(19) United States
(12) Patent Application Publication
(10) Pub. No.: US 2020/0121552 A1
(43) Pub. Date: Apr. 23, 2020

(54) ACTIVE COMPRESSION-DECOMPRESSION DEVICES AND METHODS

(71) Applicant: Zoll Circulation, Inc., San Jose, CA (US)

(72) Inventors: Byron J. Reynolds, San Jose, CA (US); David Trevor Lawrence, Mountain View, CA (US); Paolo Giacometti Pérez, North Grafton, MA (US); Gary A. Freeman, Waltham, MA (US); Anna Grace Prestezog, Sunnyvale, CA (US); Ari Manoukian, Mountain View, CA (US); Richard A. Helkowski, Redwood City, CA (US); Melanie Lynn Harris, Santa Clara, CA (US)

(21) Appl. No.: 16/660,166

(22) Filed: Oct. 22, 2019

Related U.S. Application Data
(60) Provisional application No. 62/749,035, filed on Oct. 22, 2018.

(51) Int. Cl. A61H 31/00

(52) U.S. Cl. CPC A61H 31/006; A61H 2011/005; A61H 31/008; A61H 31/005

(57) ABSTRACT

A system for performing an active compression decompression (ACD) treatment on a patient includes a platform for placement under a patient, a chest compression actuator that may include a belt configured to extend over a thorax of the patient, an upward force actuator, a coupling mechanism for coupling the upward force actuator to the thorax of the patient to transfer a decompressing force from the upward force actuator to the thorax of the patient, and a motor that is coupled to the belt, the motor configured to cause the belt to tighten about the thorax of the patient and exert a compressing force on the thorax of the patient; and cause the belt to loosen about the thorax of the patient and allow the upward force actuator to cause decompression of the patient.

### CLAIM OF PRIORITY

This application claims priority under 35 U.S.C. § 119(e) to U.S. Patent Application Ser. No. 62/749,035, filed on Oct. 22, 2018, the entire contents of which are hereby incorporated herein by reference.

### TECHNICAL FIELD

This disclosure relates to chest compression devices for cardiopulmonary resuscitation (CPR) treatment, and more particularly to active compression-decompression devices and methods.

### BACKGROUND

Cardiopulmonary resuscitation (CPR) is a well-known and valuable method of first aid used to resuscitate people who have suffered from cardiac arrest. CPR requires repetitive chest compressions to squeeze the heart and the thoracic cavity to pump blood through the body. In efforts to provide better blood flow and increase the effectiveness of bystander resuscitation efforts, various mechanical devices have been proposed for performing CPR. In one type of mechanical chest compression device, a belt is placed around the patient's chest and the belt is used to effect chest compressions. These devices have proven to be valuable alternatives to manual chest compression. The devices provide chest compressions at resuscitative rates and depths. A resuscitative rate may be any rate of compressions considered effective to induce blood flow in a cardiac arrest victim, typically 60 to 120 compressions per minute (the CPR Guidelines 2015 recommends 100 to 120 compressions per minute in adult victims), and a resuscitative depth may be any depth considered effective to induce blood flow, and typically 1.5 to 2.5 inches (the CPR Guidelines 2015 recommends 2 to 2.4 inches per compression in adults).

### SUMMARY

This document describes various systems and methods for performing an active compression and/or decompression (ACD) treatment on a patient. In some implementations, a system may include a platform for placement under a patient, a chest compression actuator comprising a belt configured to extend over a thorax of the patient, the belt configured to extend from the platform on a first side of the patient to a second side of the patient opposite the first side, an upward force actuator, a coupling mechanism for coupling the upward force actuator to the thorax of the patient to transfer a decompressing force from the upward force actuator to the thorax of the patient, a controller, and a motor that is coupled to the belt and configured to receive one or more signals from the controller, the motor configured to respond to the one or more signals from the controller to cause the belt to tighten about the thorax of the patient and exert a compressing force on the thorax of the patient and cause the belt to loosen about the thorax of the patient and allow the upward force actuator to cause decompression of the patient.

In some implementations, the upward force actuator can be configured to affix to the thorax of the patient by the coupling mechanism. In some implementations, the upward force actuator can be configured to couple to the belt, and the belt can be configured to affix to the patient by the coupling mechanism.

In some implementations, the coupling mechanism may include one or more of suction cups, gel, and adhesive.

In some implementations, the upward force actuator includes one or more of a rigid arm, a leaf spring, and an elastic material.

In some implementations, an amount of the decompression of the thorax of the patient can be adjustable based on adjusting a magnitude of the decompressing force on the thorax of the patient by the upward force actuator. In some implementations, the magnitude of the decompressing force on the thorax of the patient by the upward force actuator can be adjustable by adjusting a tension in the upward force actuator.

In some implementations, the magnitude of the decompression of the thorax of the patient can be adjustable based on adjusting a range of motion of the upward force actuator relative to the platform. In some implementations, the upward force actuator can be formed by the motor and the belt. The coupling mechanism may include an adhesive configured to affix the belt to the thorax of the patient. The motor can be configured to respond to the one or more signals from the controller to cause the belt to loosen about the thorax of the patient and enable the belt to exert the decompressing force on the thorax of the patient.

In some implementations, the belt may include a rigid material. The belt may extend from a first actuator on the first side of the patient to a second actuator on the second side of the patient. One of the first actuator or the second actuator may include the motor.

In some implementations, at least one of the first and second actuators may include a rack and pinion configuration to couple the belt to the motor. At least one of the first and second actuators can be configured to affix to an end of the belt and retract into the platform.

In some implementations, the range of the decompressing force may include a magnitude between approximately 1-25 lbs.

In some implementations, causing the belt to tighten about the thorax of the patient and exert a compressing force on the thorax of the patient may include compressing the thorax from an initial state of zero compression past a state of neutral compression to a state of full compression. The upward force actuator may decompress the thorax from the state of full compression past the state of neutral compression to the initial state of zero compression.

In some implementations, the upward force actuator decompresses the thorax from a state of full compression past a state of neutral compression and past an initial state of zero compression to a state of positive decompression.

In some implementations, the upward force actuator may include a collapsible arm that can be coupled to the platform on the first side of the patient, the second side of the patient, or both the first and second sides of the patient. The collapsible arm can be coupled to the belt or to the thorax of the patient. The collapsible arm can be configured to deform when the motor causes the belt to tighten about the thorax of the patient. The collapsible arm can be configured to re-straighten when the motor causes the belt to loosen about the thorax of the patient thereby exerting the decompressing force on the thorax of the patient.

In some implementations, the upward force actuator may include at least one rigid arm configured to couple to the belt or couple to the thorax of the patient. The rigid arm may be coupled to the platform by a hinge. The rigid arm may be configured to rotate about the hinge from a position under the platform or alongside the platform to a position over the platform. In some implementations, the rigid arm may include an adjustable pivot point for the hinge.

In some implementations, the upward force actuator may include a leaf spring, a rigid arm, or a collapsible arm configured to couple to the belt. The leaf spring, the rigid arm, or the collapsible arm can be in tension when the motor causes the belt to tighten about the thorax of the patient. The leaf spring, the rigid arm, or the collapsible arm may be configured to cause the belt to exert the decompressing force on the thorax of the patient when the motor causes the belt to loosen about the thorax of the patient.

In some implementations, the upward force actuator comprises an elastic material configured to be in tension when the motor causes the belt to tighten about the thorax of the patient and configured to exert the decompressing force on the thorax of the patient when the motor causes the belt to loosen about the thorax of the patient.

In some implementations, the leaf spring can be a first leaf spring, and the system may include a second leaf spring that can be coupled to the belt, the first leaf spring being affixed to the platform on the first side of the patient and the second leaf spring being affixed to the platform on the second side of the patient.

In some implementations, the upward force actuator may include a leaf spring, a rigid arm, or a collapsible arm configured to couple to the thorax of the patient, the leaf spring, the rigid arm, or the collapsible arm being in tension when the motor causes the belt to tighten about the thorax of the patient, and wherein the leaf spring, rigid arm or collapsible arm can be configured to cause decompression of the patient when the motor causes the belt to loosen about the thorax of the patient.

In some implementations, the system may include an arm extending from the platform over the patient from the first side of the patient to the second side of the patient, the arm being coupled to the belt and being rigid or semi-rigid. In some implementations, the system may include an arm extending from the platform over the patient, the arm being coupled to the belt or to the thorax of the patient by the upward force actuator. In some implementations, a height or a position of the arm can be adjustable to adjust a magnitude of the decompressing force of the upward force actuator on the patient. In some implementations, the arm may include a first arm and a second arm, and the first arm extends from the platform substantially perpendicular to the platform and the second arm extends from the first arm substantially parallel to the platform, and partially over the patient. In some implementations, the second arm can be adjustable relative to the first arm.

In some implementations, the upward force actuator may include an elastic material configured to be in tension when the motor causes the belt to tighten about the thorax of the patient and configured to exert the decompressing force on the thorax of the patient when the motor causes the belt to loosen about the thorax of the patient. The elastic material can include a cord or a strap. A tension or a length of the elastic material can be adjustable. In some implementations, the arm or the upward force actuator may include a sensor for measuring the decompressing force of the elastic material.

In some implementations, the upward force actuator may include a spring configured to be in tension when the motor causes the belt to tighten about the thorax of the patient and configured to exert the decompressing force on the thorax of the patient when the motor causes the belt to loosen about the thorax of the patient. A tension of the spring can be adjustable. The arm or the upward force actuator can include a sensor for measuring the decompressing force of the spring. The controller can be configured to control the motor in response to a signal from the sensor. In some implementations, a measurement of the decompressing force can be displayed on a display of the system or a remote display. The sensor can include a strain gauge.

In some implementations, the system may include a force sensor configured to measure a tension in the arm or the upward force actuator.

In some implementations, the arm can be a first arm, and the system may include a second arm coupled to the belt and configured to intersect the first arm over the thorax of the patient. The first arm or the second arm can be adjustable relative to the other of the first and second arms. The first arm or second arm may include a telescoping rod to allow for adjustment of position or height of the first or second arm relative to the platform or thorax of the patient.

In some implementations, the arm can include a series of segmented sections to permit the arm to be collapsed into a roll and to enable the arm to form a rigid arch. In some implementations, the arm can include a series of segmented sections to permit the arm to be collapsed into a roll and to enable the arm to form a rigid arch.

In some implementations, the upward force actuator can include a plurality of rods affixed to the belt, wherein each rod of the plurality can be configured for insertion into a respective receptacle on the platform to couple the rod to the platform.

In some implementations, the upward force actuator may include a plurality of rods affixed to the platform, wherein each rod of the plurality can be configured for insertion into a respective receptacle on the belt to couple the rod to the belt.

In some implementations, the system may include a first arm extending from the platform on the first side and a second arm extending from the platform on the second side. The first arm and the second arm may each be configured to couple to the upward force actuator The upward force actuator may include a strap extending from the first arm to the second arm, the strap being affixed to the belt. In some implementations, a length of the strap between the first arm and the second arm can be adjustable.

In some implementations, the belt can be configured to couple to a structure that can be separate from the platform, the belt being configured to couple to the structure by an upward force actuator, wherein the upward force actuator can be configured to exert the decompressing force on the thorax of the patient when the motor causes the belt to loosen about the thorax of the patient. In some implementations, the upward force actuator may include an elastic material. In some implementations, the elastic material may include a spring, strap or cord. In some implementations, the system may include a lever arm affixed to the belt at a first end of the lever arm and affixed to the upward force actuator at a second end that can be opposite the first end.

In some implementations, the system may include a strain gauge in communication with the upward force actuator, wherein the controller can be configured to control the motor in response to a signal from the strain gauge indicative of the decompressing force exerted by the upward force actuator.

In some implementations, the belt may include a force-distributing mechanism configured to spread out the compressing force over an area of the thorax. In some implementations, the force-distributing mechanism may include a bladder that may include one or more of foam and a plurality of tension cords. In some implementations, the leaf spring, the rigid arm, or the elastic material can be coupled to the platform by an actuator.

In some implementations, a portion of the platform can be adjustable about a pivot to support at least a portion of the patient at an angle with respect to a floor surface, wherein the platform may include a center of gravity that can be below an interface surface of the patient to stabilize the platform when the portion of the platform can be angled.

In some implementations, the system may include a sensor or a force sensor configured to measure the decompressing force of the upward force actuator. In some implementations, the controller may be configured to control the motor in response to a signal from the sensor or force sensor.

In some implementations, an amount of the decompression of the thorax of the patient can be adjustable based on adjusting a magnitude of the decompressing force on the thorax of the patient by the upward force actuator. In some implementations, the amount of decompression of the thorax can be one selected from chest displacement to a neutral point, a zero point, or past zero point.

In some implementations, a belt for integration with an active compression decompression (ACD) treatment system can include a first portion configured to couple to a thorax of a patient and provide a compressive force on the patient, a second portion configured to couple to a chest compression actuator, a third portion configured to couple to an upward force actuator that provides a decompressing force to the belt, and a fourth portion comprising a coupling mechanism configured to attach to the patient, wherein the belt can be configured to transfer the decompressing force from the upward force actuator to the patient.

In some implementations, the first portion can include a force-distributing mechanism. The third portion can include a top surface configured to couple to the upward force actuator. The fourth portion can include a bottom surface of the belt that can be opposite the top surface. The top surface can be connected to the bottom surface by one or more tensile elements configured to transfer the decompressing force from the top surface of the belt to the bottom surface of the belt.

In some implementations, the upward force actuator can include a collapsible rod that can be integrated into the belt along a length of the belt, the collapsible rod configured to deform when a compressing force can be applied by the chest compression actuator and re-straighten when the chest compression actuator ceases application of the compressing force.

In some implementations, the coupling mechanism of the belt may include one or more of suction cups, adhesive, or a gel. In some implementations, the coupling mechanism of the belt can be configured to provide a force between 1-25 lbs. In some implementations, the upward force actuator can include a rigid rod integrated into the belt along a length of the belt, and wherein the belt may include a first end configured to couple to a first downward actuator, and a second end configured to couple a second downward actuator, the first end being opposite the second end. In some implementations, the first end and second end of the belt each include a linear gear rack.

In some implementations, the third portion may include a hook configured to couple to the upward force actuator, the upward force actuator comprising an elastic device. The third portion can include a lever, wherein the hook can be located at an end of the lever. The upward force actuator can include a plurality of semi-rigid rods affixed to the third portion of the belt, wherein each rod of the plurality can be configured for insertion into a respective receptacle on a platform to couple the belt to the platform. In some implementations, the belt can include a high-tensile strength material that may include one or more of fabric. In some implementations, the one or more tensile elements include one or more of an elastic cord or a spring. In some implementations, the force-distributing mechanism may include a bladder that may include one or more of foam and a plurality of tension cords. In some implementations, the bladder can be air filled or foam filled.

In some implementations, a system for performing an active compression decompression (ACD) treatment on a patient can include a platform for placement under a patient, a chest compression actuator configured to extend over a thorax of the patient, the chest compression actuator configured to extend from the platform, a first arm coupled to the platform on the first side of the patient, a second arm coupled to the platform on a second side of the patient, an upward force actuator coupled to the first arm and the second arm, a coupling mechanism for coupling the upward force actuator to the thorax of the patient to transfer a decompressing force from the upward force actuator to the thorax of the patient. A motor may be coupled to the chest compression actuator and may be configured to cause the chest compression actuator to compress the thorax of the patient and exert a compressing force on the thorax of the patient and cause the chest compression actuator to release the compressing force and allow the upward force actuator to cause decompression of the patient.

In some implementations, the chest compression actuator can include a belt configured to extend over a thorax of the patient, the belt configured to extend from the platform on a first side of the patient to a second side of the patient opposite the first side, and wherein the motor causes the belt to tighten about the thorax of the patient and exert a compressing force on the thorax of the patient and causes the belt to loosen about the thorax of the patient and allow the upward force actuator to cause decompression of the patient.

In some implementations, the coupling mechanism can include one or more of suction cups, gel, and adhesive. In some implementations, the chest compression actuator can include a piston. In some implementations, the upward force actuator may include a strap. In some implementations, the upward force actuator can be configured to affix to the thorax of the patient.

In some implementations, the upward force actuator can be configured to couple to the chest compression actuator, and wherein the chest compression actuator can be configured to affix to the patient by a coupling mechanism.

In some implementations, the upward force actuator can include an elastic material. The elastic material can include one or more of an elastic cord, a spring, or a bungee. The upward force actuator can include a cord, and the cord can be coupled to each of the first arm and the second arm by a respective pulley.

In some implementations, the system may include a sensor for measuring the decompressing force of the upward force actuator. In some implementations, the controller can be configured to control the motor in response to a signal from the sensor.

In some implementations, an amount of the decompression of the thorax of the patient can be adjustable based on adjusting a magnitude of the decompressing force on the thorax of the patient by the upward force actuator. The magnitude of the decompressing force on the thorax of the patient by the upward force actuator can be adjusted by adjusting a tension in the upward force actuator. The magnitude of the decompression of the thorax of the patient can be adjustable based on adjusting a range of motion of the upward force actuator relative to the platform.

In some implementations, a system for performing an active compression decompression (ACD) treatment on a patient includes a platform for placement under a patient, a chest compression actuator configured to extend over a thorax of the patient, the chest compression actuator configured to extend from the platform, a structure that extends over the patient and that can be rigid, an upward force actuator coupled to the structure, a coupling mechanism for coupling the upward force actuator to a thorax of the patient to transfer a decompressing force from the upward force actuator to the thorax of the patient A motor may be coupled to the chest compression actuator and may be configured to cause the chest compression actuator to exert a compressing force on the thorax of the patient and cause the chest compression actuator to release the compressing force and allow the upward force actuator to cause decompression of the patient.

In some implementations, the chest compression actuator can include a belt configured to extend over a thorax of the patient, the belt configured to extend from the platform on a first side of the patient to a second side of the patient opposite the first side, and wherein the motor causes the belt to tighten about the thorax of the patient and exert a compressing force on the thorax of the patient and causes the belt to loosen about the thorax of the patient and allow the upward force actuator to cause decompression of the patient. The coupling mechanism can include one or more of suction cups, gel, and adhesive. The chest compression actuator can include a piston. In some implementations, the structure can be attached to the platform. The structure can be a rigid arm or rod that extends partially over the patient, and the arm or rod can be adjustable relative to the platform such that the arm or rod includes a telescoping rod or adjustable hinge height. The structure can be separate from the platform. The upward force actuator can be coupled to the structure and affixed directly to the patient. The upward force actuator can be coupled to the structure and coupled to the belt, wherein the belt can be configured to affix to the patient by a coupling mechanism.

In some implementations, the upward force actuator can include an elastic material. The elastic material can include one or more of an elastic cord, a spring, or a bungee.

In some implementations, the system includes a sensor for measuring the decompressing force of the upward force actuator. In some implementations, the controller can be configured to control the motor in response to a signal from the sensor.

In some implementations, the structure can include a first arm and a second arm, wherein the first arm extends from the platform substantially perpendicular to the platform and the second arm extends from the first arm substantially parallel to the platform, and partially over the patient. The second arm can be adjustable relative to the first arm.

In some implementations, the upward force actuator can include an elastic material. The elastic material can include one or more of an elastic cord, a spring, or a bungee. An amount of the decompression of the thorax of the patient can be adjustable based on adjusting a magnitude of the decompressing force on the thorax of the patient by the upward force actuator.

In some implementations, the magnitude of the decompressing force on the thorax of the patient by the upward force actuator can be adjusted by adjusting a tension in the upward force actuator. In some implementations, the magnitude of the decompression of the thorax of the patient can be adjustable based on adjusting a range of motion of the upward force actuator relative to the platform.

In some implementations, a system for performing an active compression decompression (ACD) treatment on a patient includes a platform for placement under a patient, a chest compression actuator configured to extend over a thorax of the patient, the chest compression actuator configured to extend from the platform, a semi-rigid structure coupled to the platform, a coupling mechanism for coupling the upward force actuator to a thorax of the patient to transfer a decompressing force from the upward force actuator to the thorax of the patient. A motor may be coupled to the chest compression actuator and may be configured to cause the chest compression actuator to exert a compressing force on the thorax of the patient and cause the chest compression actuator to release the compressing force and allow the semi-rigid structure to cause decompression of the patient.

In some implementations, the chest compression actuator includes a belt configured to extend over a thorax of the patient. The belt may be configured to extend from the platform on a first side of the patient to a second side of the patient opposite the first side. The motor may cause the belt to tighten about the thorax of the patient and exert a compressing force on the thorax of the patient and cause the belt to loosen about the thorax of the patient and allow the upward force actuator to cause decompression of the patient. In some implementations, the coupling mechanism can include one or more of suction cups, gel, and adhesive. The chest compression actuator can include a piston. The semi-rigid structure can include a leaf spring. The semi-rigid structure can include a collapsible rod. The collapsible rod can include a telescoping rod. The semi-rigid structure can be affixed directly to the patient. The semi-rigid structure can be coupled to the belt, and the belt can be configured to affix to the patient by a coupling mechanism.

In some implementations, the system includes a sensor for measuring the decompressing force of the semi-rigid structure. The controller can be configured to control the motor in response to a signal from the sensor. In some implementations, an amount of the decompression of the thorax of the patient can be adjustable based on adjusting a magnitude of the decompressing force on the thorax of the patient by the upward force actuator. The magnitude of the decompressing force on the thorax of the patient by the upward force actuator can be adjusted by adjusting a tension in the upward force actuator. In some implementations, the magnitude of the decompression of the thorax of the patient can be adjustable based on adjusting a range of motion of the upward force actuator relative to the platform.

In some implementations, a method of providing active compression decompression (ACD) treatment includes providing a system for performing an active compression decompression (ACD) treatment to a patient. The system includes a platform for placement under a patient, a chest compression actuator comprising a belt configured to extend over a thorax of the patient, the belt configured to extend from the platform on a first side of the patient to a second side of the patient opposite the first side, an upward force actuator, a coupling mechanism for coupling the upward force actuator to the thorax of the patient to transfer a decompressing force from the upward force actuator to the thorax of the patient, a controller, and a motor that can be coupled to the belt and configured to receive one or more signals from the controller, the motor configured to respond to the one or more signals from the controller to cause the belt to tighten about the thorax of the patient and exert a compressing force on the thorax of the patient and cause the belt to loosen about the thorax of the patient and allow the upward force actuator to exert a decompressing force on the thorax of the patient. The method may include placing the patient on the platform to align the thorax of the patient with the belt, coupling the upward force actuator to the thorax of the patient directly or via the belt, and initiating operation of the system to cause repeated cycles of tightening and loosening of the belt about the thorax of the patient.

In some implementations, the upward force actuator can include a strap. In some implementations, the upward force actuator can be configured to affix directly to the thorax of the patient.

In some implementations, the upward force actuator can be configured to couple to the belt, and the belt can be configured to affix to the patient by the coupling mechanism. The upward force actuator may include an elastic material. In some implementations, the elastic material can include one or more of an elastic cord, a spring, or a bungee. The upward force actuator can include a cord, and the cord can be coupled to each of a first arm and the second arm by a respective pulley. The system can include a sensor for measuring the decompressing force of the upward force actuator. The controller can be configured to control the motor in response to a signal from the sensor. An amount of the decompression of the thorax of the patient can be adjustable based on adjusting a magnitude of the decompressing force on the thorax of the patient by the upward force actuator. The magnitude of the decompressing force on the thorax of the patient by the upward force actuator can be adjusted by adjusting a tension in the upward force actuator. The magnitude of the decompression of the thorax of the patient can be adjustable based on adjusting a range of motion of the upward force actuator relative to the platform.

In some implementations, a system for performing an active compression decompression (ACD) treatment to a patient includes a platform for placement under a patient, a belt configured to extend over a thorax of the patient, the belt configured to extend from the platform on a first side of the patient to a second side of the patient opposite the first side, the belt being configured to couple to the thorax of the patient, the belt comprising a rigid or semi-rigid material that causes the belt to maintain an approximate shape when the belt can be coupled to the thorax of the patient, a first actuator affixed to the platform on the first side of the patient, the first actuator coupled to the belt on a first end of the belt, a second actuator affixed to the platform on the second side of the patient, the second actuator coupled to the belt on a second end of the belt that can be opposite the first end, and a controller configured for controlling the first actuator and the second actuator to cause the belt to tighten about the thorax of the patient and exert a compressing force on the thorax of the patient and cause the belt to loosen about the thorax of the patient and exert a decompressing force on the thorax of the patient.

In some implementations, a system for performing an active compression decompression (ACD) treatment to a patient includes a platform for placement under a patient, a chest compression actuator comprising a belt configured to extend over a thorax of the patient, the belt configured to extend from the platform on a first side of the patient to a second side of the patient opposite the first side the belt being configured to couple to the thorax of the patient, a coupling mechanism, an adjustable arm, wherein the arm extends from a side of the platform and partially over the patient, an elastic material extending from the arm and coupled to the belt, a controller, and a motor that can be coupled to the belt and configured to receive one or more signals from the controller, the motor configured to respond to the one or more signals from the controller to cause the belt to tighten about the thorax of the patient and exert a compressing force on the thorax of the patient, while tensioning the elastic material and cause the belt to loosen about the thorax of the patient, allowing the elastic material to lift the belt to exert a decompressing force on the thorax of the patient.

In some implementations, a system for performing an active compression decompression (ACD) treatment on a patient includes a platform for placement under a patient, a chest compression actuator configured to extend over a thorax of the patient, an upward force actuator, a coupling mechanism for coupling the upward force actuator to the thorax of the patient allowing the upward force actuator to exert a decompressing force on the thorax of the patient, a controller, a motor that can be coupled to the upward force actuator and configured to receive one or more signals from the controller, the motor configured to respond to the one or more signals from the controller to cause the chest compression actuator to exert a compressing force on the thorax of the patient and cause the chest compression actuator to cease exerting the compressing force on the patient and enable the upward force actuator to cause decompression of the patient.

In an aspect, a method for performing an active compression decompression (ACD) treatment on a patient, includes providing a system including a platform for placement under a patient. The system includes a chest compression actuator configured to extend over a thorax of the patient, the chest compression actuator configured to extend from the platform. The system includes a structure that extends over the patient and that is rigid, an upward force actuator coupled to the structure, and a coupling mechanism for coupling the upward force actuator to a thorax of the patient to transfer a decompressing force from the upward force actuator to the thorax of the patient. The system includes a motor that is coupled to the chest compression actuator and configured to cause the chest compression actuator to exert a compressing force on the thorax of the patient and cause the chest compression actuator to release the compressing force and allow the upward force actuator to cause decompression of the patient. The method includes placing the patient on the platform to align the thorax of the patient with the chest compression actuator, coupling the upward force actuator to the thorax of the patient directly or via the chest compression actuator, and initiating operation of the system to cause repeated cycles of tightening and loosening of the belt about the thorax of the patient.

The devices and methods for active compression-decompression (ACD) for use in cardiopulmonary resuscitation (CPR) treatment may provide at least one or more of the following advantages. The ACD device is configured to compress and decompress a patient's chest during CPR treatment. Decompression of the patient's chest (e.g., pulling up on the patient's chest) may increase negative intrathoracic pressure and may cause more blood to flow through the patient than performing compressions alone. For some patients, in some implementations, an impedance threshold device with a check valve may be positioned in an airway of the patient when the patient is intubated. For some patients, the valve allows air to exit the lungs of the patient when the patient's chest is compressed, and prevents air from entering the lungs when the patient's chest is decompressed. Preventing air from entering the chest during decompression may allow more blood to be pumped through the patient. The ACD device may include a load-distributing device that spreads a force of compression and/or decompression on the patient, further reducing a likelihood of injuring the patient (e.g., relative to manual compressions or decompressions with conventional devices).

The ACD device performs automatic ACD treatment of a patient. A user of the device need not perform compressions and decompression of the patient manually, but can program the ACD device to perform ACD treatment continuously or as needed. The ACD device may perform compressions and decompressions of consistent depth so as not to over compress the chest of the patient and over decompress the chest of the patient, each of which may potentially cause injury to the patient. The ACD device can be calibrated to a particular compression force, compression/decompression depth, and/or frequency to maximize the effectiveness of the ACD treatment on the patient. One or more sensors (e.g., force sensors, accelerometers, etc.) can be used to measure parameters (e.g., depth, frequency, force, etc.) of the compressions and/or decompressions and provide feedback to the ACD device. The ACD device may include a mechanism to limit the maximum decompression and/or compression of the ACD treatment. In some implementations, the limits can be adjusted based on the patient and can be applied based on feedback received from the one or more sensors. For example, if the force being applied in a compression or decompression exceeds a threshold as measured by the one or more sensors, the ACD device reduces the force being applied to the patient. In some implementations, hardware limitation(s) are included to prevent compression and/or decompression forces and/or depths from exceeding preset thresholds.

The ACD device can be modular such that the compression and/or decompression elements of the ACD device can be added or removed as required for treatment. For example, the ACD device can include a decompression device (arm, leaf spring, etc.) that can pivot or retract out of the way when not needed for treatment (e.g., during defibrillation or other treatment).

The details of one or more embodiments of the ACD devices and methods for ACD treatment are set forth in the accompanying drawings and the description below. Other features, objects, and advantages of the ACD devices and methods will be apparent from the description and drawings, and from the claims.

### DESCRIPTION OF DRAWINGS

FIG. 1 shows a perspective view of an ACD device.

FIGS. 2A-2B show perspective views of an ACD device platform.

FIG. 3A shows an axial view of an ACD device including an example upward force actuator.

FIG. 3B shows an example upward force actuator for the ACD device of FIG. 3A.

FIG. 3C shows an example arm for supporting an upward force actuator.

FIG. 3D shows an ACD device including an example upward force actuator.

FIG. 3E shows an perspective view of an ACD device.

FIGS. 4A-4B show an ACD device including example upward force actuators including collapsible arms.

FIGS. 5A-5E show an ACD device including example upward force actuators including a rigid belt.

FIG. 6 shows an example retractable arm for an ACD device.

FIG. 7A shows a top view of an example ACD device.

FIGS. 7B-7E show example upward force actuators for the ACD device of FIG. 7A.

FIGS. 8A-8C show examples of collapsible upward force actuators for an ACD device.

FIGS. 9A-9B show ACD devices including examples of upward force actuators.

FIG. 10 shows an example compression belt for an ACD device.

FIGS. 11A-11B show ACD device including example upward force actuators.

FIGS. 12-13 show an example upward force actuator configured to couple to an external structure for an ACD device.

FIG. 14 shows an ACD device including an example of an upward force actuator.

FIG. 15 shows an ACD device including an example of an upward force actuator including a feedback sensor.

FIG. 16 shows example processes for performing ACD treatment using the ACD devices of FIGS. 1-15.

FIG. 17 shows an example computing device for controlling one or more operations of the ACD devices of FIGS. 1-16 and 18A-18B and performing the process of FIG. 16.

FIG. 18A shows a perspective view of an ACD device including a piston.

FIG. 18B shows an axial view of an ADC device including a piston.

FIG. 18C shows a perspective view of an ACD device including a piston.

Like reference symbols in the various drawings indicate like elements.

### DETAILED DESCRIPTION

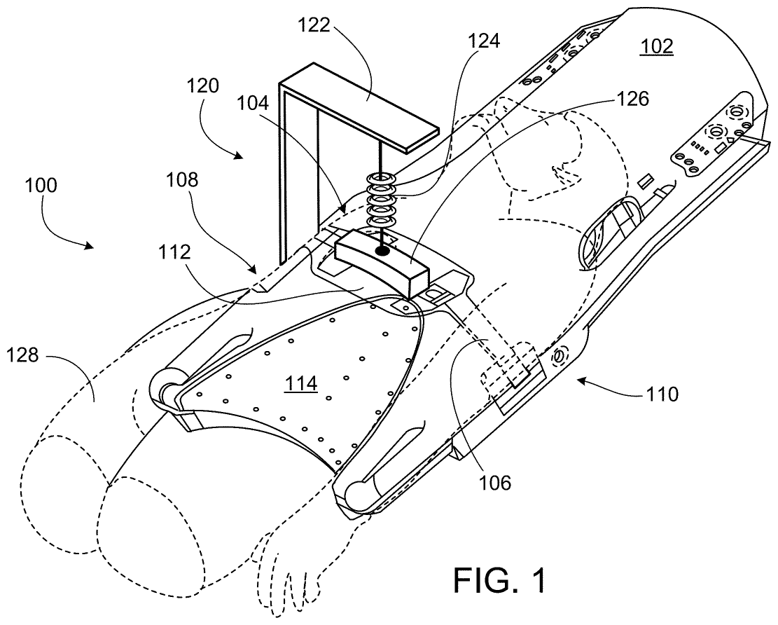

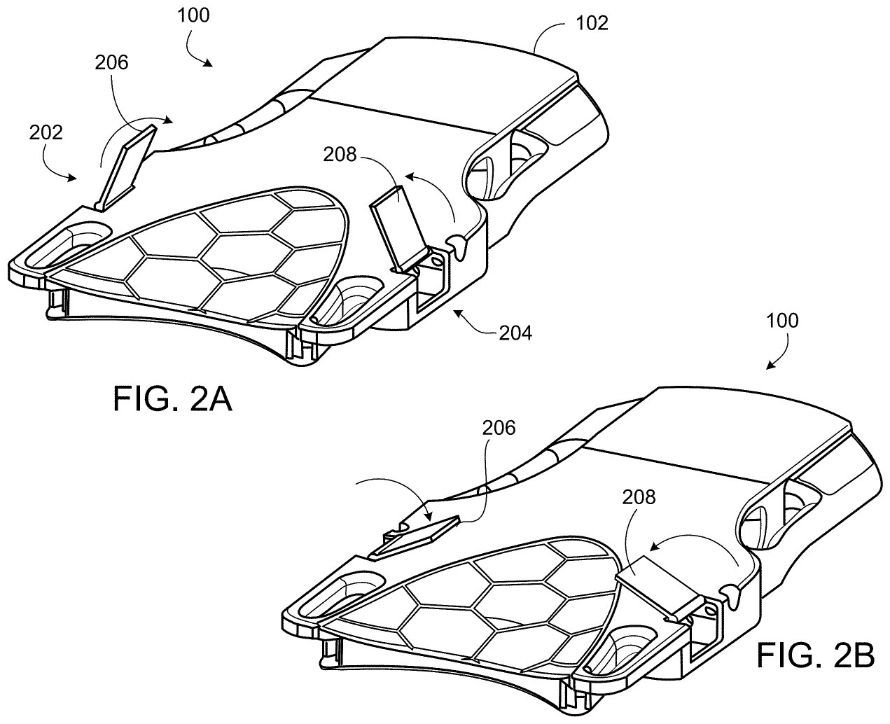

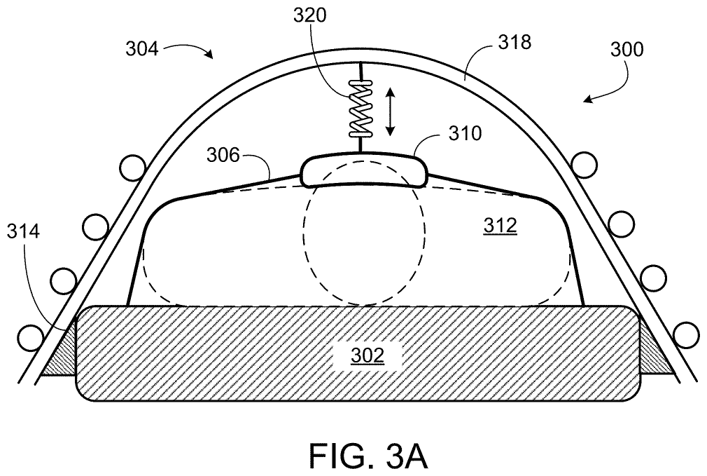

FIG. 1 shows an embodiment of an active compression-decompression (ACD) device 100 configured to automatically administer ACD cardiopulmonary resuscitation (CPR) treatment. The ACD device 100 includes a platform 102, and a chest compression actuator 104. The ACD device 100 includes an upward force actuator 120. While FIG. 1 depicts one example of an upward force actuator 120, a number of examples of upward force actuators are described in detail below with respect to FIGS. 2A-16, which may also be utilized in place of or in combination with upward force actuator 120 in the ACD device 100 of FIG. 1. The upward force actuator 120 is configured to apply a lifting force in an upward direction on the chest of the patient to decompress the chest of the patient. For the purposes of description, an upward direction is a direction away from a surface on which the platform 102 is positioned, while a downward direction is toward the surface on which the platform is positioned. Thus, when a patient is positioned on the platform, a downward force on the chest of the patient from the chest compression actuator 104 compresses the patient (and is alternatively referred to as a compressing force). Likewise, an upward force from the upward force actuator 120 on the chest of the patient decompresses the patient (and is alternatively referred to as a decompressing force).

The platform 102 is configured to support a patient. For ACD treatment, the platform 102 supports the patient such that a chest region (e.g., thorax) of the patient rests between the chest compression actuator 104 and the platform 102. The exact position of the patient can vary depending on the size of the patient relative to the platform 102. In some implementations, the platform includes a rotatable joint so that a portion of the platform 102 may bend and lift a head and shoulder region of the patient (e.g., during ACD treatment). The platform 102 may be sized such that a center of gravity of the ACD device 100 is underneath the thorax portion of the patient, which may not be lifted. The compression portion 114 of the platform that does not lift supports the thorax of the patient. This configuration balances the ACD device 100 under the patient's body and permits the head and shoulder regions of the patient to remain lifted by the ACD device 100 without external support.

The chest compression actuator 104 includes all elements of the ACD device 100 which work to compress the patient's thorax for the compression phase of the ACD treatment. The chest compression actuator 104 thus includes a belt 106, motors/actuators (not shown), and a force distributing mechanism 112. In some implementations, the chest compression actuator 104 includes a downward force actuator configured to exert a downward force on the patient. In some implementations, the chest compression actuator includes a compressive actuator that can exert a downward force on the patient but also other forces for compressing the chest of the patient, the other forces including some lateral portion (e.g., compressing the sides of the patient's chest inward).

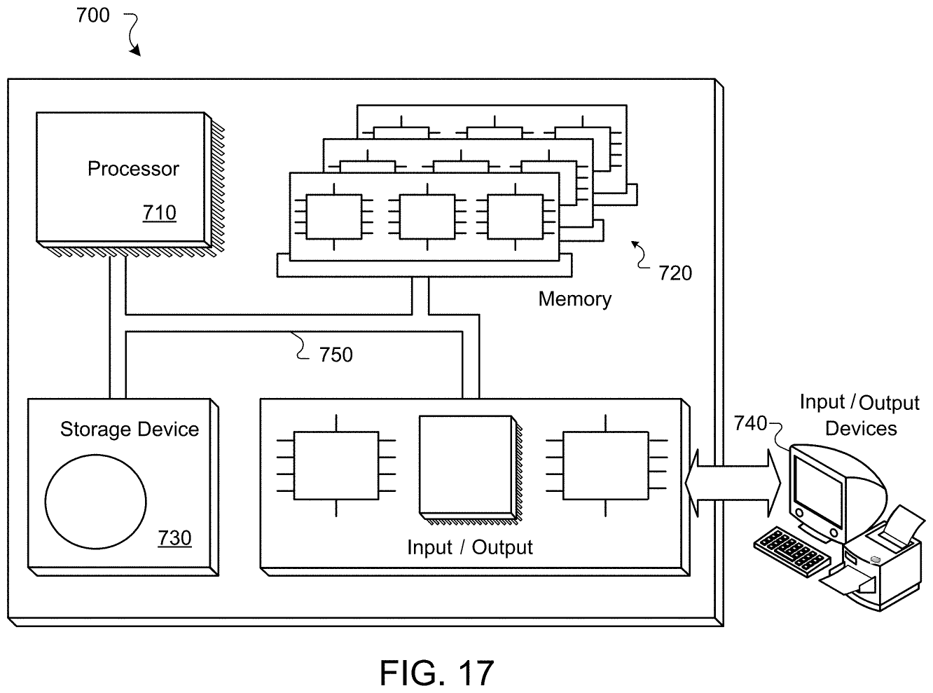

In some implementations, the chest compression actuator 104 is configured to apply compressions to the patient with a compression belt 106. The belt 106 is coupled to the platform 102 at a first side 108 of the platform on a first side of the patient and at a second side 110 of the platform on a second side of the patient. The platform 102 provides a housing for a drive train of the chest compression actuator 104 and control system for the ACD device 100. The control system, provided anywhere in the device, can include a processor and may be operable to control tightening operation of the belt and to provide output on a user interface disposed on the housing. Operation of the device can be initiated and adjusted by a user through a control panel and/or a display operated by the control system to provide feedback regarding the status of the device to the user. The motor(s) that actually cause the belt to tighten about the patient to compress the patient's chest are controlled by a controller (described in further detail below). The controller causes the motor(s) to tighten and/or loosen the belt 106 by sending control signals to the motor(s). As described in further detail with respect to FIG. 17, the controller controls the phase of the compression cycle, and the length, frequency, depth, etc. of compressions by the chest compression actuator 104. The controller may also control the phase of the decompression cycle, and the length, frequency, amount, etc. of decompressions by the upward force actuator, depending on the particular configuration of the upward force actuator.

The chest compression actuator 104 includes a load-distribution portion 112. In some implementations, the load distribution portion is located at the mid-portion of the belt and left and right belt ends. When fitted on a patient, the load distribution portion 112 is disposed over the anterior chest wall of the patient, and the left and right belt ends extend posteriorly over the right and left axilla of the patient, under the patient's arms (e.g., under the armpits of the patient) to connect to their respective actuators, e.g., lateral drive spools (e.g., to couple with the platform at first side 108 and second side 110). The drive spools at first side 108 and second side 110 are disposed laterally on either side of the housing. The belt 106 is secured to these drive spools. The lateral drive spools are in turn driven by a motor (not shown) also disposed within the housing, through a drive shaft and drive belt. The belt 106 can be attached to the lateral drive spools such that, upon rotation of the drive spools, the belt 106 is pulled into the platform and spooled upon the lateral spools, thereby drawing the belt downward to compress the chest of the patient. After the chest of the patient is compressed, the chest compression actuator 104, driven by the motor and controlled by the controller, loosens the belt 106 around the patient. The patient's chest is permitted to decompress as the chest compression actuator 104 ceases application of a compressing force and loosens the belt 106 around the patient. The cycle of controlling the chest compression actuator 104 to tighten the belt to compress the patient's chest and subsequently controlling the chest compression actuator 104 to loosen the belt and allow the patient's chest to decompress is one compression cycle of the ACD CPR treatment. The compression of the patient during this cycle is referred to as the compression phase, and the decompression of the patient during this cycle is referred to as the decompression phase. The chest compression actuator 104 can include one or more implementations of the AutoPulse® device of ZOLL Medical Corporation of Chelmsford, Mass., such as those described in U.S. application Ser. No. 15/942,292 and U.S. application Ser. No. 15/942,309, incorporated herein by reference in entirety.

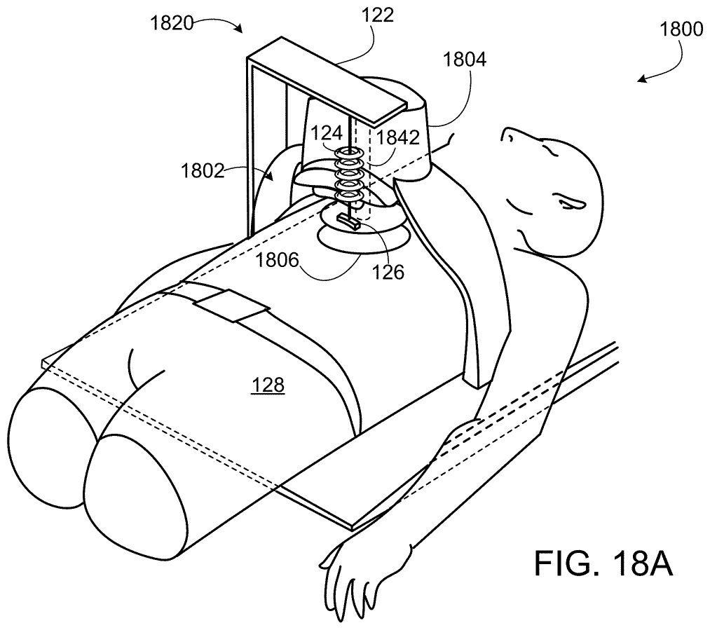

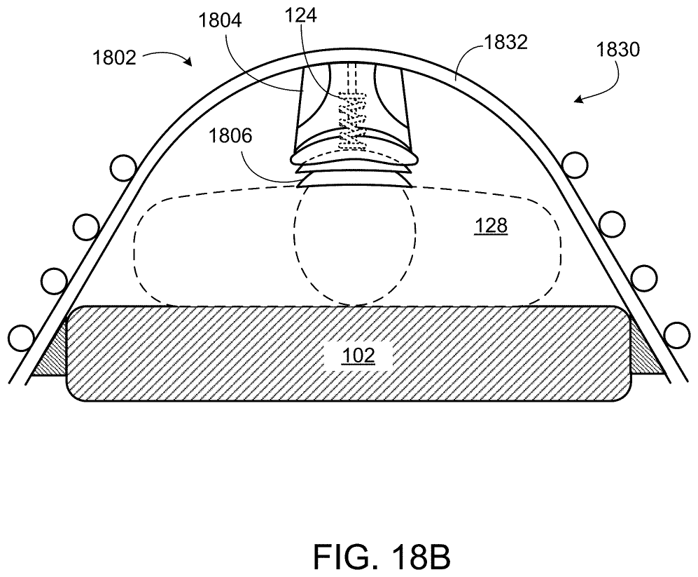

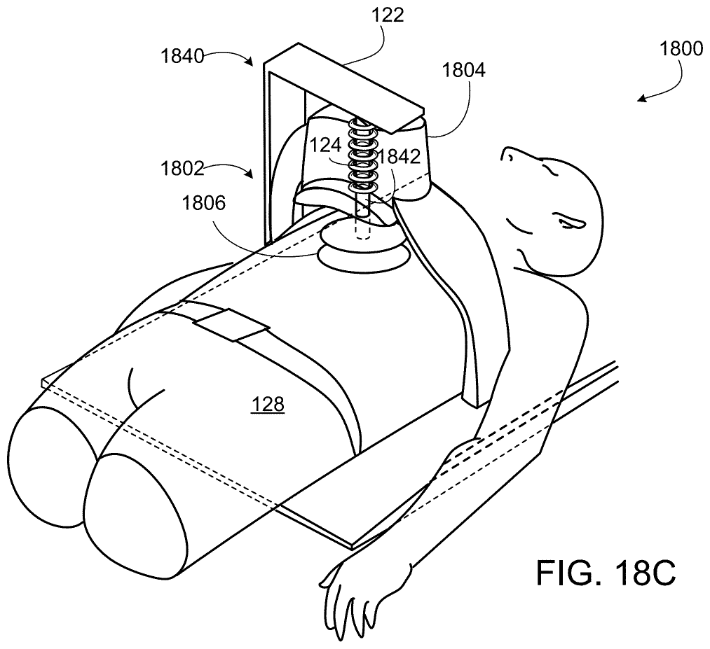

In some implementations, the chest compression actuator 104 includes a piston-based compressing actuator instead of or an addition to the chest compressive belt 106. The piston-based chest compression actuator 106 delivers a compressive force to the chest of a patient. The piston-based chest compression actuator works with the upward force actuator to perform ACD treatment and is described in further detail below with respect to FIGS. 18A-18C.

The upward force actuator, e.g., upward force actuator 120, is a device that applies an upward force on the thorax (e.g., chest) of the patient. The upward force actuator includes a mechanical device configured to pull up on the patient's chest (either directly or via the chest compression actuator 104) to decompress the chest of the patient. The upward force actuator lifts the chest wall, decompresses the chest cavity of the patient, and decreases intrathoracic pressure in the patient.

Upward force actuator 120 includes an arm 122 having a first end coupled to the platform 102, on one side of the patient, and a second end extending over and above the patient. An elastic element 124 extends from the second end of the arm and is coupled via a coupling mechanism 126 directly to the patient's chest or is coupled to the belt 106 or load distribution portion 112 or plate, which is coupled to the patient's chest.

The arm 122 can be rigid or semi-rigid and supports the elastic element 124 over the chest of the patient 128. The arm 122 can include a single member or two or more members that can be assembled and/or moved relative to one another. The arm 122 can be configured to fold up from a stored position (e.g., next to or underneath the platform 102). The arm 122 can be configured to be a telescoping arm, a foldable arm, etc. The arm 122 can be set to different heights above the platform 102 to accommodate various chest sizes of patients. The arm 122 can be adjusted using a sliding mechanism, one or more notches, etc. In some implementations, the arm can be loosened and fixed into place with a thumbscrew, wingnut, or similar such mechanism. The elastic element 124 is configured to couple to the arm 122. In some implementations, the elastic element is detachable from the arm 122. In some implementations, the elastic element 124 is affixed to the arm 122. The arm can be arcuate, form a right angle, etc. over the patient. The position of the arm 122 over the patient can be adjustable (e.g., laterally adjustable) so that the elastic element 124 can be finely adjusted into place without requiring repositioning of the patient on the platform. For example, at least a portion of the arm 122 can swivel and lock into place as needed.

In some implementations, the ACD device 100 is combined with an intubation device (not shown) including a check valve that prevents air from entering the chest cavity during decompressions. During ACD CPR treatment, decompressing the chest cavity and decreasing intrathoracic pressure each help to increase the amount of blood pumped through the patient and thus improve the effectiveness of the compression treatment. The upward force actuator includes a mechanical device that is coupled to the platform 102 and to the thorax of the patient. The upward force actuator 120 is configured to decompress the thorax of the patient during the decompression phase. When the belt 106 of the chest compression actuator 104 is loosened, the upward force actuator 120 is able to lift the chest wall to decompress the patient. When the belt 106 of the chest compression actuator 104 is tightened, the upward force actuator 120 does not prevent the chest from compressing, though the upward force actuator 120 may remain coupled to the thorax of the patient through the entire compression cycle. The upward force actuator 120 can include a variety of embodiments for providing the upward force on the thorax of the patient. Various embodiments of the upward force actuator are described below in relation to FIGS. 2A-16.

In some implementations, the ACD device 100 may not include the belt 106 or load distribution portion 112 as described with reference to FIG. 1, but may include another device for the chest compression actuator 104. For example, the ACD device may include a piston or other rigid device to compress the chest of the patient. A piston-based chest compression actuator is described below in reference to FIGS. 18A-18C.

FIGS. 2A-2B shows perspective views of an ACD device 100 platform 102 and example coupling mechanisms 202, 204. The coupling mechanisms 202, 204 are configured to receive the belt 106 of the chest compression actuator 104. As shown in FIG. 2A, the upward force actuator in the form of spring levers 206, 208 push upward on the belt of the chest compression actuator 104 during the decompression phase. The belt 106, which is affixed to the patient's chest by an adhesive, is tightened around the patient during the compression phase. The belt 106 is subsequently loosened around the patient and the patient's chest is permitted to decompress (e.g., in response to a decompressing force by the upward force actuator). As shown in FIG. 2B, the spring levers 206, 208 collapse during the compression phase, allowing the belt 106 of the chest compression actuator 104 to compress around the patient.

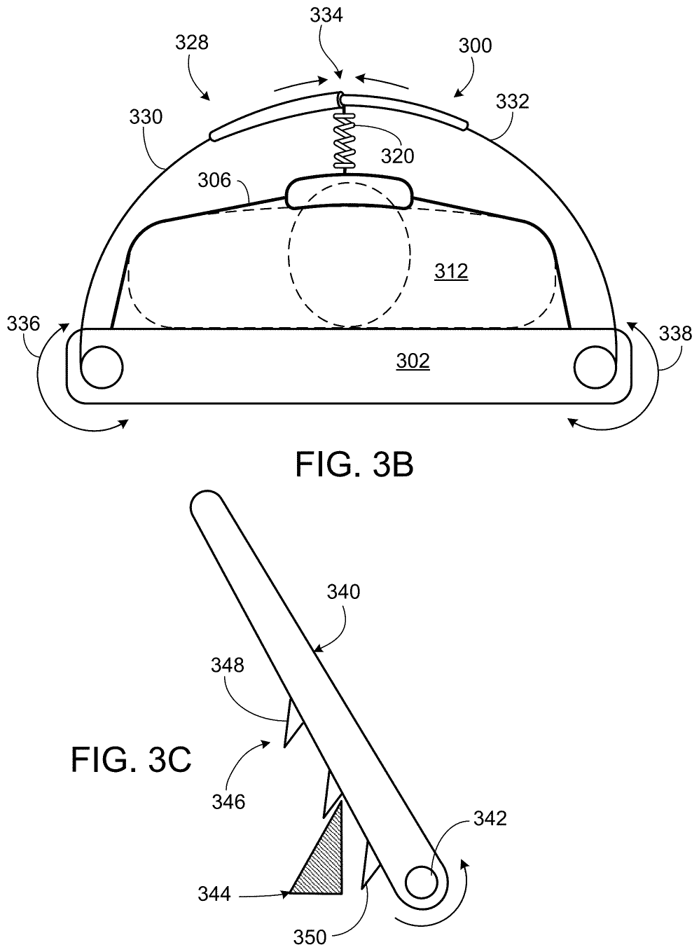

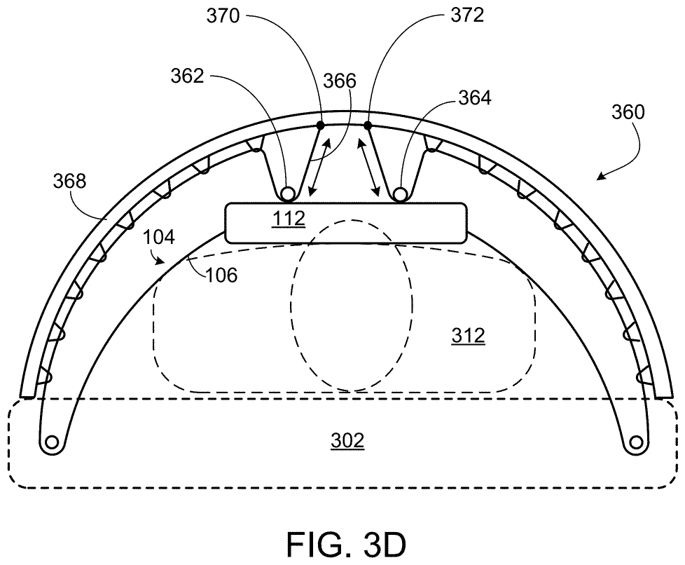

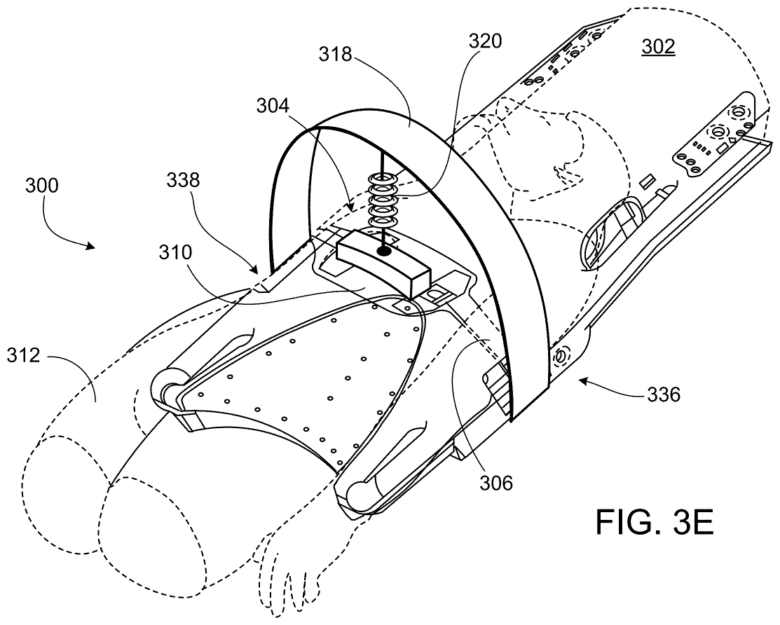

FIG. 3A shows an axial view of an ACD device 300 including an example upward force actuator 304. A patient 312 is on the platform 302 and positioned under the upward force actuator 304 and under the belt 306 of the chest compression actuator (e.g., chest compression actuator 104 of FIG. 1).

The upward force actuator 304 includes a rigid or semi-rigid structure 318, e.g., one or more rods or arms, and an elastic element 320. The structure 318 of the upward force actuator 304 is coupled to the platform 302 at a first side 314 of the platform and at a second side 316 of the platform, on first and second sides of the patient 312, respectively. The structure 318 thus extends over the thorax of the patient 312 when the patient is on the platform 302. In some implementations, the structure 318 need not extend completely from the first side 314 to the second side 316, but can extend partway (e.g., about halfway) from the first side to the second side over the thorax of the patient 312. In some implementations, the structure 318 couples to the platform by inserting into a corresponding slot in the platform 302 at the first side 314 and another corresponding slot in the platform at the second side 316, and subsequently fastened in place by a thumbscrew or similar mechanism. The structure 318 can be removed from the platform 302 to allow the patient 312 to lay down on the platform 302 and then placed over the patient for performing ACD treatment. The structure 318 may be adjustable, e.g., the height of the structure 318 relative to the platform 302 may be adjusted by changing the position of the structure in one or more of the notches or grooves 317. The tension of the elastic element 320 may also be adjustable.

In some implementations, at least a portion of the structure 318 is coupled to the platform 302 (e.g., at side 314, side 316, or both sides) by rotating hinges. The structure 318 can be rotated over the patient 302 from a position that is approximately planar with the platform to the approximately orthogonal position shown in FIG. 3A. In some implementations, the structure 318 is coupled on either side 314 or side 316 by a rotating hinge. The structure 318 can rotate from a storage position (e.g., under the platform 302, alongside the platform, etc.) over the patient for ACD treatment and coupled on the opposing side with a latch or other coupling mechanism.

The elastic element 320 is coupled to the structure 318 and to the patient 312. The elastic element 320 includes one or more of a spring (e.g., a coil spring), a bungee cord, an elastic material, etc. The elastic element 320 is configured to couple to the thorax of the patient 312 by a coupling mechanism. The coupling mechanism of the elastic element 320 can include one or more of a gel, suction cup(s), or adhesive or other plate or base that sticks to the skin of the patient 302. The elastic element 320 of the upward force actuator 304 pulls up on the chest of the patient 312. During the decompression phase of the ACD compression cycle, when the belt 306 is loosened around the patient 312, the upward force actuator 304 pulls the chest wall upward and decompresses the chest of the patient 312. During the compression phase of the ACD compression cycle, the elasticity of the elastic element 320 of the upward force actuator 304 allows the chest compression actuator 104 to tighten the belt 106 and compress the thorax of the patient 312. The elastic element 320 extends during the compression phase and exerts an upward force on the chest wall of the patient.

In some implementations, the elastic element 320 is configured to couple with the chest compression actuator 104, such as to the belt 106. The elastic element 320 can couple to the chest compression actuator 104 using a hook, latch, or hook and loop mechanism, e.g., a Velcro® material, etc. Here, the belt 306 is configured to couple with the thorax of the patient by suction cups, an adhesive, etc. The elastic element 320 of the upward force actuator 304 pulls up on the belt 306 (or other portion of the chest compression actuator 104) affixed to the patient's chest, thereby pulling the chest wall upward during the decompression phase of the ACD compression cycle when the belt 306 is loosened around the patient 312. The elastic element 320 allows the chest compression actuator 104 to tighten the belt 106 and compress the thorax of the patient 312 during the compression phase of the ACD compression cycle.

The amount of decompression of the thorax of the patient may be adjustable by adjusting a magnitude of the decompressing force on the thorax of the patient to achieve a desired level of decompression. The zero position of the chest refers to the resting position of the chest before the commencement of compressions. After commencement of compressions, the shape of the thorax will remodel due to the breakdown of the sterno-costal cartilage, sternal and costal fractures, and changes in the biomechanical properties of other anatomical features. The neutral position of the chest refers to the static resting position that the chest returns to after the commencement of compressions when the compressions are paused.

The structure 318 and/or the elastic element 320 of the upward force actuator 304 can be tuned to provide a specific force or force curve for a desired amount of decompression of the patient. For example, the structure 318 and/or the elastic element 320 of the upward force actuator 304 can be configured to provide between 1-25 lbs. of predetermined decompression force. In some embodiments, the structure 318 and elastic element 320 are configured to provide maximum upward force (e.g. 3, 5, 10, 15, 20 lbs.) at the point of deepest compression, and that decreases as the depth approaches either the zero or neutral point during the decompression phase. In other words, at the start of the decompression phase, the force is greater than at the end of the decompression phase, e.g. the force at end of the decompression phase is, for example, 80%, 50%, 20%, 10%, 5%, or 1% of the force at the start of the decompression phase.

In some embodiments, the upward force actuator 304 can be configured to deliver a sufficient amount of force to achieve a specific depth at the point of maximum decompression upstroke that is either below or above either the zero point or neutral point. In some embodiments, the achieved upward displacement of the chest may be the zero or neutral position of the chest. In another example, the structure 318 and/or the elastic element 320 of the upward force actuator 304 can be configured to provide decompression force sufficient to achieve an upward displacement of the chest relative to the neutral or zero position of the chest of about 0.25 to 4 inches. On a typical patient, approximately 5-20 lbs. of upward force would be needed to achieve an upward displacement of 2 inches relative to the neutral or zero position.

FIG. 3B shows an example upward force actuator 328 for the ACD device 300 of FIG. 3A. The upward force actuator 328 includes a first arm 330, a second arm 332 and an elastic element 320. The arm 330 and the arm 332 couple over the patient 312 by coupling mechanism 334. The arms 330, 332 are each coupled to the platform 302 independently of one another at sides 314, 316, respectively. The arm 330 can couple to the platform 302 by coupling mechanism 336, and the arm 332 can couple to the platform by coupling mechanism 338. The coupling mechanisms 336, 338 can each include a rotatable hinge, ball and socket, or other such coupling mechanism. The arms 330, 332 can independently move and stow when not in use for ACD treatment. When the patient 312 is positioned for ACD treatment, one or both of the arms 330, 332 can be moved and locked into place and/or with each other by coupling mechanism 334. Coupling mechanism 334 can include a socket and plug, latch, or other coupling mechanism. In some implementations, when a single arm 330 or 332 is used, the arm can be locked into place (e.g., by a thumbscrew on a ball and socket mechanism at 336 or 338, a spring latch, etc.). The elastic element 320 can be suspended from the arm 330, 332 and provide a decompression force as described above in relation to FIG. 3A.

FIG. 3C shows an example arm 340 for supporting an upward force actuator, such as the upward force actuator of FIG. 3B. The arm 340 is configured to fix in place at one of several angles with respect to the platform (not shown) to size the ACD device for patients of different sizes. In some implementations, arm 340 can include arm 330 or arm 332 of FIG. 3B. The arm 340 is coupled to the platform by a coupling mechanism 342, such as a hinge, ball-and-socket joint, etc. The arm 340 includes several notches or extensions 346 that provide a purchase for a corresponding bar 344. The arm 340 can ratchet up or down by slipping one or more of the extensions 346 over the bar 344 and fix the arm 340 in place at different angles with respect to the platform. For example, for a small patient (e.g., a child), the arm 340 can be fixed at a smaller angle with respect to the platform, and the bar can be set into one of the higher notches (e.g., notch 348). For example, for a large patient, the arm 340 can be fixed at a larger angle with respect to the platform, and the bar can be set into one of the lower notches (e.g., notch 350). The angle of the arm 340 can be used to tune the decompressing force of the upward force actuator of the ACD device 300. The above described adjustment feature, e.g., one or more arms having notches or extensions and corresponding bars for adjusting the angle and/or height of the upward force actuator may be applied to not only the upward force actuator of FIG. 3B, but also to any of the other upward force actuators of the ACD devices described herein.

FIG. 3D shows an ACD device including an example upward force actuator 360. The upward force actuator 360 includes a system with a belt 366. The belt 366 couples with two pulleys 362, 364, which may be coupled to the chest compression actuator 104. The chest compression actuator 104 is pulled upward by the belt 366 that is actuated from one or more actuators on either side of the platform or below the platform 302. Belt 366 is configured to tighten and pull up on the patient's chest (or on chest compression actuator 104 adhered to the chest) to apply a decompressing force on the patient's chest. In the compression phase, the chest compression actuator 104 compresses the patient's chest (and pulls on the belt 366).

In some implementations, the upward force actuator 360 works with the chest compression actuator 104 as a system of two belts with two motors, or one belt that is connected and a motor that spins clockwise or anticlockwise. The chest compression actuator 104 includes a belt 106 that is tightened with the motor (not shown) going a first direction (e.g., counterclockwise) for compression. The motor rotates in a second direction (e.g., clockwise) to tighten the belt 366 and lift the belt 104 to decompress the patient's chest. A coupling device 112 attaches to the patient's chest (e.g., by suction cup or other methods) for decompression. In some implementations, arm(s) 368 may provide a portion of the decompression force. The belts 106, 366 perform compression/decompression actively (e.g., rather than passively with an elastic element). In some implementations, belts 106 and 366 are a single continuous belt that loops though arm(s) 368, over pulleys 362, 364, fastening to the arm at 370, 372, and attaches to the patient at 112. Optionally, the belts 106, 366 can be a plurality of separate belts. In some implementations, the upward force actuator 360 can be a separate unit which may be retrofit to an existing chest compression device, or it may be integral to a chest compression device.

FIG. 3E shows a perspective view of an ACD device including the upward force actuator 304 that includes the structure 318 and elastic element 320. The belt 306 can be coupled to the elastic element 120 (as shown) or directly to the patient 312.

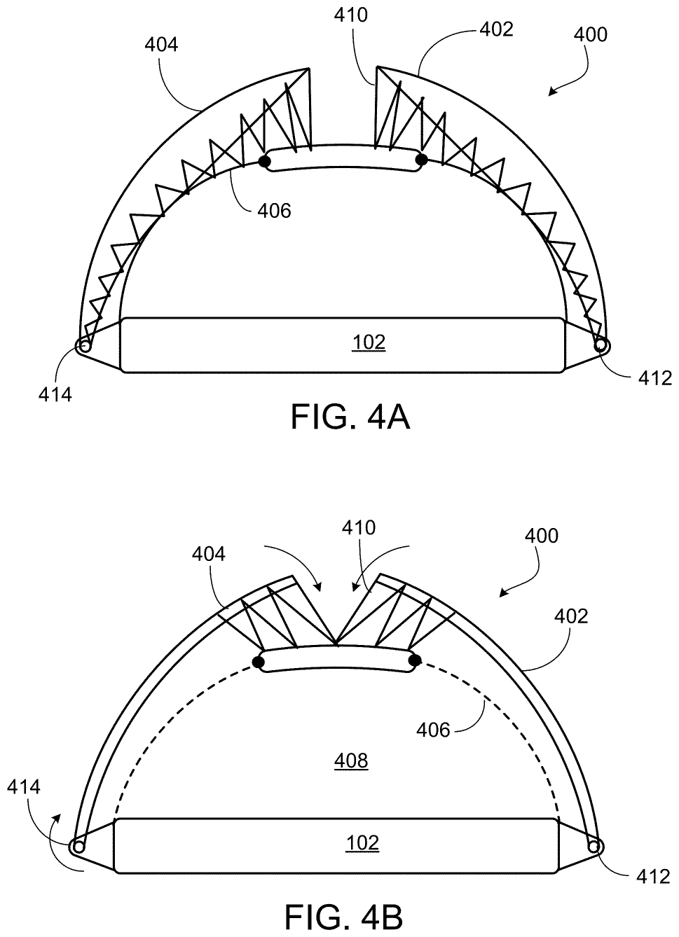

FIGS. 4A-4B show an ACD device including an example upward force actuator 400 including support arms 402, 404, which may or may not be collapsible. The upward force actuator 400 includes a first arm 402 coupled to the platform 102 by a coupling mechanism 412. The upward force actuator 400 may include one or more additional arms 404 coupled to the platform 102 by a coupling mechanism 414. In some embodiments, the coupling mechanism may also include an elastic element 410 for providing the upward force. In some embodiments, arms 402, 404 may include a semi-rigid material such that the arm can bend in response to a force and then reform (e.g., re-straighten or partially re-straighten) to the original form when the force is removed for providing the upward spring force, or alternatively, the arms 402, 404 may be rigid with a spring in the hinge where it attaches to the base. In some embodiments, there may be both an elastic element 410 and the arms 402, 404 may be semi-rigid or have a spring at the hinge. The arms 402, 404 are configured to be in tension during the compression phase and spring back to the original form during the decompression phase. The arms 402, 404 are each affixed either directly to the thorax of the patient 408 or to the chest compression actuator 104, which is in turn affixed to the patient's thorax. When the chest compression actuator 104 tightens the belt 106 around the patient to compress the chest of the patient, the arms 402, 404 buckle or bend, as shown in FIG. 4B. The arms 402, 404 exert an upward force on the patient (and/or the belt 106).

In some embodiments incorporating semi-rigid arms, when the belt 106 is loosened during the decompression phase, the arms 402, 404 each spring back to the original form shown in FIG. 4A. Because the arms 402, 404 are affixed to the patient 408 (and/or to the belt 106), the re-straightening of the arms pulls up on the chest wall of the patient and applies a decompressing force to the patient. The magnitude of the decompressing force applied can be tuned by altering the materials of the arms 402, 404, the lengths of the arms 402, 404, or the heights of each of the arms 402, 404 above the patient 408. The arms 402, 404 can include aluminum, carbon fiber, glass-filled polycarbonate, metal or plastic. For semi-rigid arms, the arms 402, 404 may include metal, plastic, carbon fiber, polyurethane overmolded beryllium-copper leaf springs. The arms can be between 5-24 inches above the platform to adjust for patients of different sizes (e.g., to accommodate chest sizes between 10-36 inches in diameter) and to exert decompression forces of different magnitudes. In certain examples, the arms 402, 404 and or elastic element 410 may be configured to exert between 1-25 lbs. of force on the patient.

In some implementations, the ACD devices described herein as utilizing a belt as the chest compression actuator for compressing a patient's thorax may not include the belt but instead may include another device for the chest compression actuator 104. For example, the ACD device may include a piston or other rigid device to compress the chest of the patient. Portions of the upward force actuator, such as arms 402, 404, and/or a spring or elastic element can couple to the piston device and exert the upward decompressing force on the piston, which is affixed to and pulls up upon the chest of the patient. Alternatively, the arms, spring or elastic element can be coupled directly to the patient's thorax and pull up upon the chest of the patient. An upward force actuator including a piston is described in further detail with respect to FIGS. 18A-18B, below.

The arms 402, 404 are coupled to the platform 102 by coupling mechanisms 412, 414, respectively. As stated above, the coupling mechanisms can include one or more of a rotating joint, ball-and-socket joint, etc. The arms 402, 404 can be stowed to the sides of the platform until the patient 408 is positioned for ACD treatment, whereupon the arms 402, 404 can then be moved into place and affixed to the patient and/or the belt 106.

The arms 402, 404 can be tuned to provide a specific force or force curve for a desired amount of decompression of the patient. For example, the arms 402, 404 can be configured to provide between 1-25 lbs. of predetermined decompression force. In some embodiments, the arms 402, 404 are configured to provide maximum upward force (e.g. 3, 5, 10, 15, 20 lbs.) at the point of deepest compression, and that decreases as the depth approaches either the zero or neutral point during the decompression phase. In other words, at the start of the decompression phase, the force is greater than at the end of the decompression phase, e.g. the force at end of the decompression phase is, for example, 80%, 50%, 20%, 10%, 5%, or 1% of the force at the start of the decompression phase.

In some embodiments, the upward force actuator 400 can be configured to deliver a sufficient amount of force to achieve a specific depth at the point of maximum decompression upstroke that is either below or above either the zero point or neutral point. In some embodiments, the achieved upward displacement of the chest may be the zero or neutral position of the chest. In another example, the arms 402, 404 of the upward force actuator 400 can be configured to provide decompression force sufficient to achieve an upward displacement of the chest relative to the neutral or zero position of the chest of about 0.25 to 4 inches. On a typical patient, approximately 5-20 lbs. of upward force would be needed to achieve an upward displacement of 2 inches relative to the neutral or zero position.

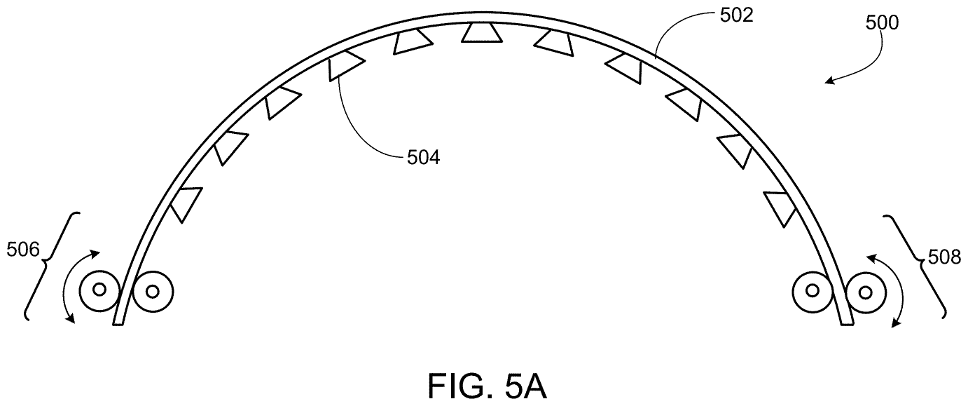

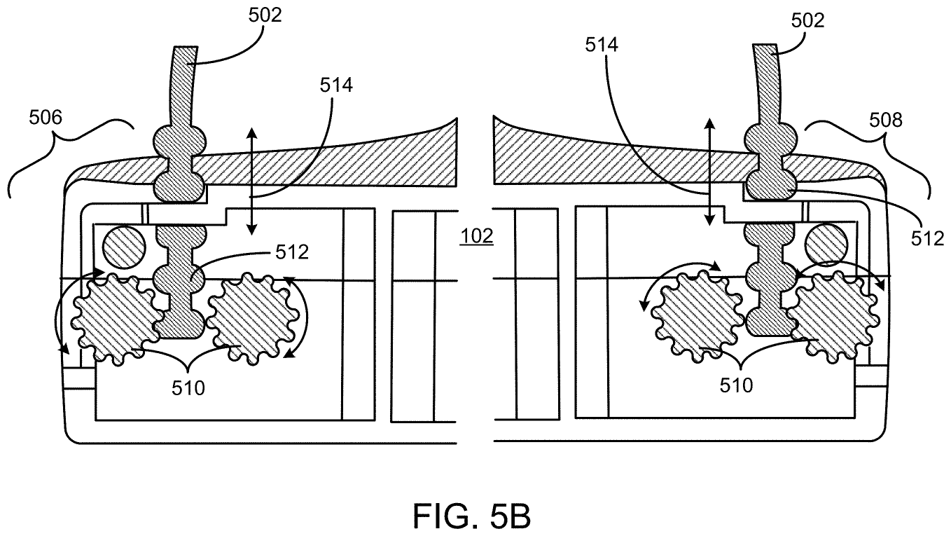

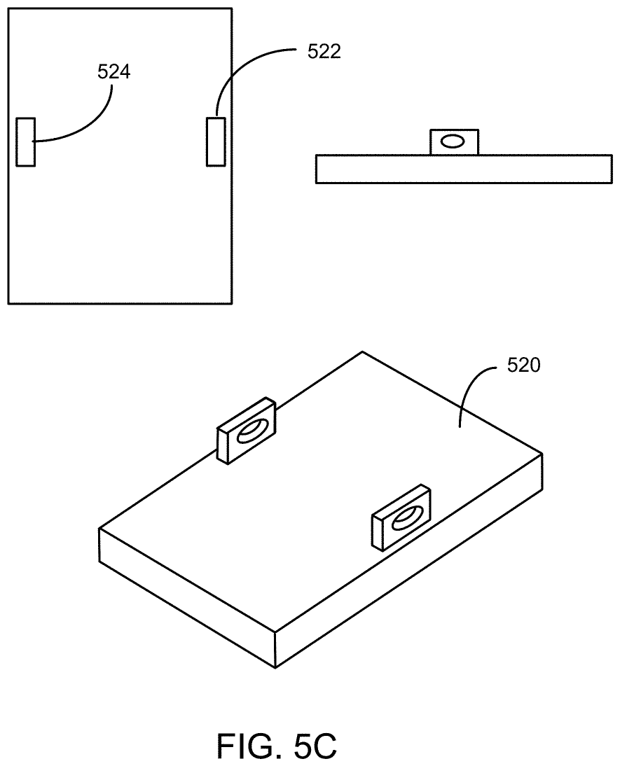

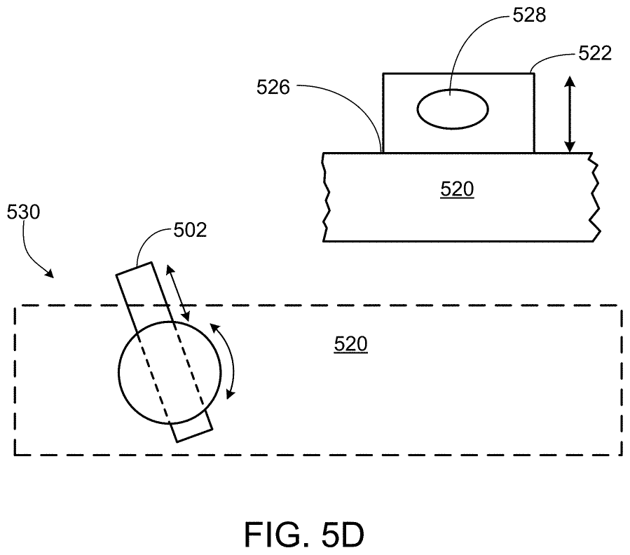

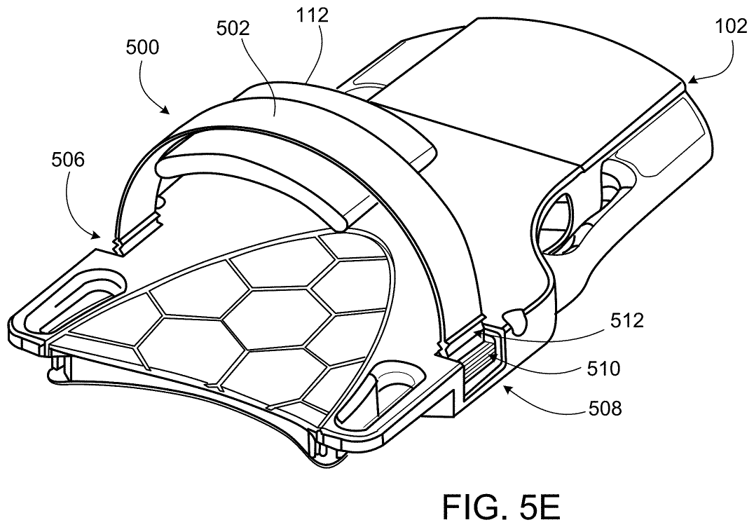

FIGS. 5A-5E show an ACD device including example upward force actuators including a rigid belt. The upward force actuators that include the rigid material also form the chest compression actuator, and are configured to adhere to the patient to both exert compression and decompression forces on the thorax of the patient.

Turning to FIGS. 5A and 5E, an upward force actuator 500 includes a rigid material 502. In some implementations, the rigid material 502 also forms the belt 106 described above and is a portion of the chest compression actuator 104. The rigid material 502 includes a coupling mechanism 504 for coupling to the thorax of the patient. In some implementations, the coupling mechanism can include one or more of suction cups, dermal adhesive, gel, etc. for coupling to the chest wall of the patient or to a separate chest compression actuator. In some implementations, an adhesive can include at least one of the materials described in Table 1, below.

TABLE 1
Typical properties of common classes of medical adhesives

| | | Nature | Synthetic | | | |
|---|---|---|---|---|---|---|
| Property | Acrylic | Rubber | Rubber | Polyolefin | Polyurethane | Silicone |
| Tack | low to high | high | high | medium | low | low to |
| | | | | | | high |
| Peel Adhesion | medium to | high | high | medium | low to | medium |
| | high | | | | medium | |
| Cohesive Strength | low to high | high | high | low | low to | high |
| | | | | | medium | |
| Adhesion Stability | poor | poor | poor | medium | medium | excellent |
| upon Aging | | | | | | |
| Plasticizer | low to | low | low | low | medium | good |
| Resistance | medium | | | | | |
| Oxidation | good | poor | poor | poor | good | excellent |
| Resistance | | | | | | |
| Adhesive Color | clear | yellow | clear to | clear to | clear to straw | clear |
| | | | straw | straw | | |
| Solvent Resistance | high | fair | fair | fair | high | excellent |
| Permeability to | poor | poor | poor | poor | poor | excellent |
| Air | | | | | | |
| MVTR | good | poor | poor | poor | good | fair |
| Repositionability | poor | poor | poor | poor | fair | excellent |
| on Skin | | | | | | |
| low Skin | good | poor | good | good | good | excellent |
| Sensitivity | | | | | | |
| Low Skin Trauma | poor | poor | poor | good | good | excellent |
| Cost | medium | low | low | medium | high | high |

Actuators 506, 508 on each side of the patient actuate the rigid material 502 both up and down relative to the platform 102 to compress the thorax of the patient and decompress the thorax of the patient. In some implementations, the rigid material 502 is inserted into the actuators 506, 508 in the platform 102 after the patient is positioned on the platform for ACD treatment.

The actuators 506, 508 each include a coupling mechanism to enable motors of the actuators to drive each end of the rigid material up and down (e.g., shown by arrows 514) to exert decompression and compression forces, respectively. For example, as shown in FIG. 5B, the rigid material 502 can include rack gearing 512, and the motors can include pinion elements 510 to drive the rack gearing 512 up and down relative to the platform 520. Each pinion 510 rotates in response to signals received by a controller, which can control the amount of movement of the rigid material 502 and consequently the magnitude of the compression force or the decompression force on the patient. Additionally, the controller is configured to control the frequency of the compressions, as described in further detail below with respect to FIG. 17.

The actuators 506, 508 can be tuned to provide a specific force or force curve for a desired amount of decompression of the patient. For example, the actuators 506, 508 can be configured to provide between 1-25 lbs. of predetermined decompression force. In some embodiments, the actuators 506, 508 are configured to provide maximum upward force (e.g. 3, 5, 10, 15, 20 lbs.) at the point of deepest compression, and that decreases as the depth approaches either the zero or neutral point during the decompression phase. In other words, at the start of the decompression phase, the force is greater than at the end of the decompression phase, e.g. the force at end of the decompression phase is, for example, 80%, 50%, 20%, 10%, 5%, or 1% of the force at the start of the decompression phase.

In some embodiments, the upward force actuator 500 can be configured to deliver a sufficient amount of force to achieve a specific depth at the point of maximum decompression upstroke that is either below or above either the zero point or neutral point. In some embodiments, the achieved upward displacement of the chest may be the zero or neutral position of the chest. In another example, the actuators 506, 508 of the upward force actuator 500 can be configured to provide decompression force sufficient to achieve an upward displacement of the chest relative to the neutral or zero position of the chest of about 0.25 to 4 inches. On a typical patient, approximately 5-20 lbs. of upward force would be needed to achieve an upward displacement of 2 inches relative to the neutral or zero position.

The rigid material 502 of the upward force actuator 500 extends from the actuator 506 to the actuator 508 when performing ACD treatment. The rigid material 502 can include one or more of plastic, fiberglass, aluminum, carbon fiber, glass-filled polycarbonate, carbon fiber, polyurethane, overmolded beryllium-copper leaf springs. The rigid material 502 of the upward force actuator 500 may be configured to affix to the thorax of the patient. The rigid material is affixed to the patient as described above. When the actuators drive the rigid material 502 up relative to the platform during the decompression phase of the compression cycle, the rigid material pulls upward on the chest wall, decompressing the chest. When the actuators drive the rigid material 502 down relative to the platform during the compression phase of the compression cycle, the rigid material pulls downward on the chest wall, compressing the chest. The rigid material 502 moves directly up and down to pull up/down on the chest wall, minimizing or avoiding squeezing the sides of the patient.

FIGS. 5C-5D show examples of actuators 504, 506 for the ACD device 500. FIG. 5C shows a platform 520 for supporting the patient. The platform 520 includes first actuator 522 and second actuator 524. The actuators are fixed to the rigid material 502. For example, the actuators 522, 524 can be fixed to the rigid material 502 by clamps. In some implementations, the rigid material 502 loops through slots (e.g., slot 528) and fastens back on itself with a snap fastener, etc. FIG. 5D shows a side view of the platform 520 of FIG. 5C. The actuator 522 is shown from the side with slot 528. The actuator 522 moves in and out of the platform 520 to move the rigid material 502 up and down with respect to the platform to apply compression forces and decompression forces, respectively. In some implementations, the actuators can pivot to rotate the rigid material 502 out of the way of the patient. For example, if the patient is ceasing ACD treatment, the actuators, shown by example actuator 530, can pivot the rigid material 502 up over the head of the patient so that the rigid material is approximately planar with the platform 502 and out of the way of the patient, without requiring that the rigid material be removed or detached from the rest of the ACD device 500. The actuator 522 can be tuned to provide a specific force or force curve for a desired amount of decompression of the patient as described above.

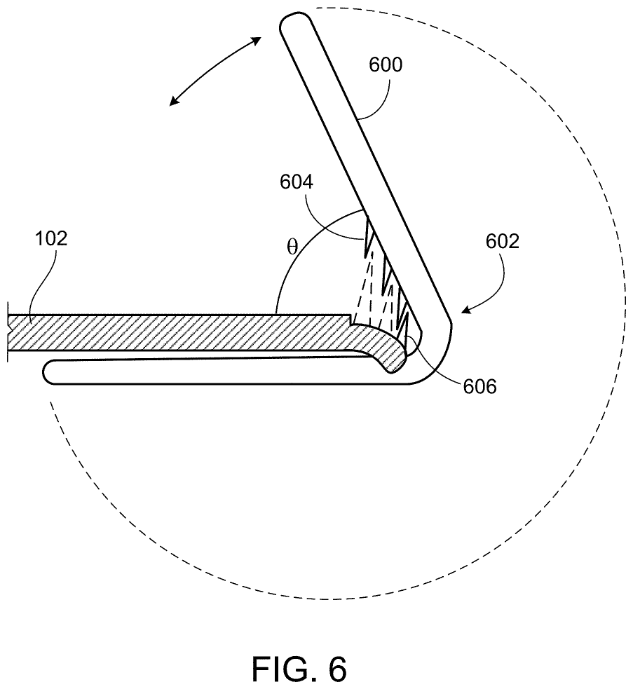

Turning to FIG. 6, an example retractable arm 600 for the various arm, rod, lever or leaf based ACD devices described herein is configured for rotating below the platform 102. For example, the arm 600 can include the rigid arms or collapsible arms described above in reference to FIG. 1 and FIGS. 3A-4B. The joint 602 can include a ball and socket joint. A ball and socket joint allows the arm 600 to pivot and rotate to tune the magnitude of the compression and decompression forces exerted by the upward force actuator and the chest compression actuators of the ACD device. In some implementations, the joint 602 includes a hinge to allow the arm to rotate below the platform. In some implementations, as described in relation to FIG. 3C, the arm 600 can include notches or extensions 604. The arm can be set into place against a bar 606 to set the angle θ of the arm with respect to the platform 102. The angle of the arm 600 can be changed to accommodate patients of different sizes and to tune the magnitude of the decompression force of the upward force actuator.

The angle of the arm 600 can be tuned to provide a specific force or force curve for a desired amount of decompression of the patient. For example, the arm 600 can be configured to provide between 1-25 lbs. of predetermined decompression force. In some embodiments, the arm 600 is configured to provide maximum upward force (e.g. 3, 5, 10, 15, 20 lbs.) at the point of deepest compression, and that decreases as the depth approaches either the zero or neutral point during the decompression phase. In other words, at the start of the decompression phase, the force is greater than at the end of the decompression phase, e.g. the force at end of the decompression phase is, for example, 80%, 50%, 20%, 10%, 5%, or 1% of the force at the start of the decompression phase.

In some embodiments, the arm 600 can be configured to deliver a sufficient amount of force to achieve a specific depth at the point of maximum decompression upstroke that is either below or above either the zero point or neutral point. In some embodiments, the achieved upward displacement of the chest may be the zero or neutral position of the chest. In another example, the arm 600 can be configured to provide decompression force sufficient to achieve an upward displacement of the chest relative to the neutral or zero position of the chest of about 0.25 to 4 inches. On a typical patient, approximately 5-20 lbs. of upward force would be needed to achieve an upward displacement of 2 inches relative to the neutral or zero position.

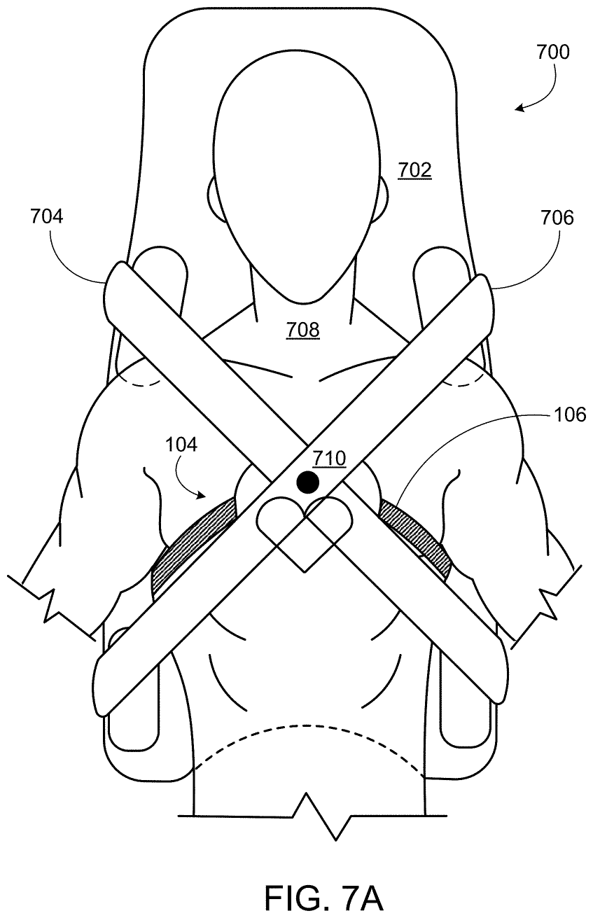

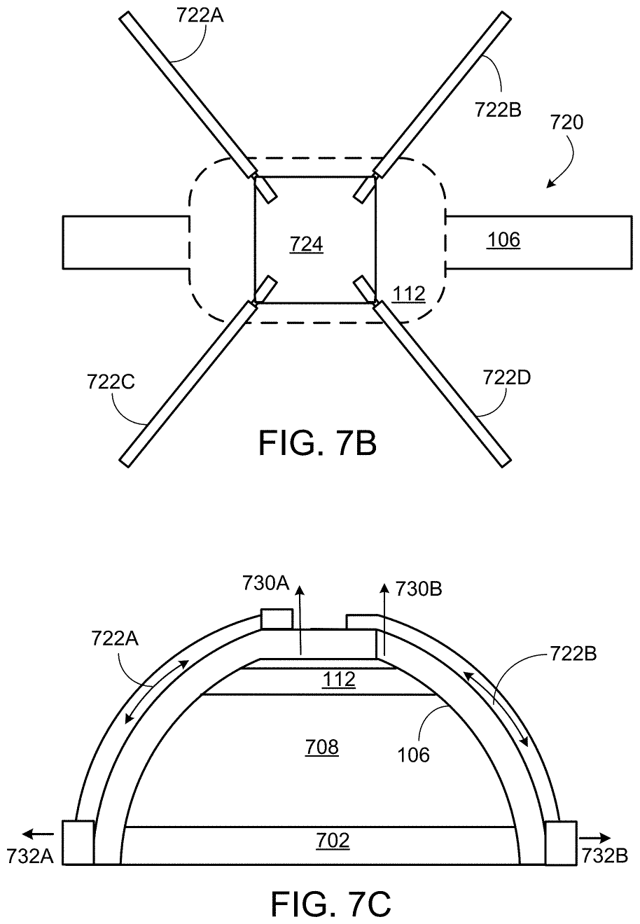

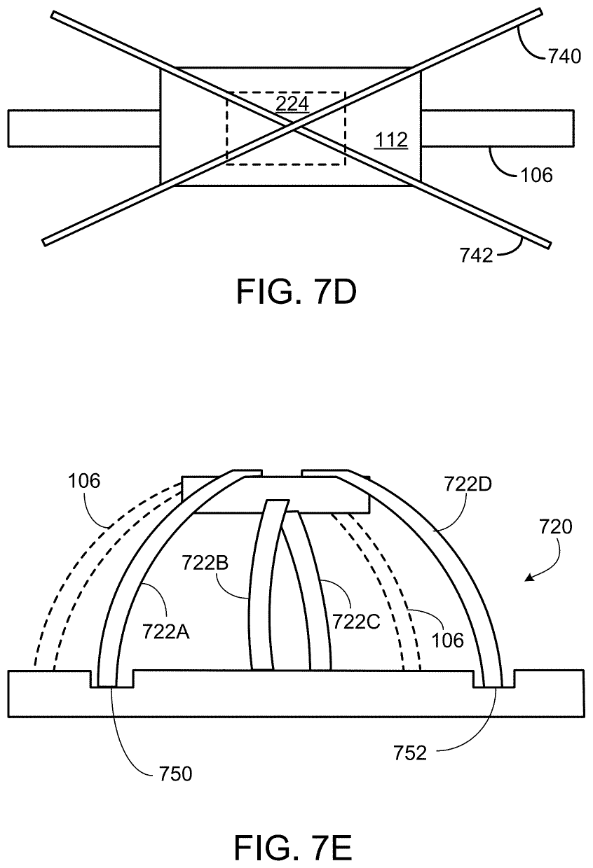

FIG. 7A shows a top view of an example ACD device 700. The ACD device 700 includes an upward force actuator 712 including two arms 704, 706 that form an “X” configuration over the thorax of the patient 708. The arms 704, 706 can be rigid arms or collapsible arms (or a combination of the two) as described above. The arms 704, 706 cross at approximately a center 710 of the chest of the patient and are configured to provide a decompressing force on the patient's sternum during the decompression phase. The addition of a second arm over the patient helps to stabilize the upward force actuator 712 during the compression cycles and reduces shear forces on the patient 708 by the upward force actuator. As with the upward force actuators described above, the arms 704, 706 can be configured to affix to the chest compression actuator 104 (which would in turn be affixed to the patient 708), or the arms 704, 706 can be affixed to the patient directly by a coupling mechanism (e.g., dermal adhesive, suction cups, gel, etc.). The arms 704, 706 are coupled to the platform 702 at positions 714a, 714b, 714c, and 714d. Positions 714a-b are above the shoulders of the patient 708 and positions 714c-d are below the armpits of the patient 708 when the patient is positioned on the platform. The positions 714a-d are away from the patient on the platform to further reduce shear forces of the arms 704, 706 on the sides of the patient near where the arms are positioned relative to the platform 702.

FIGS. 7B-7E show example upward force actuators for the ACD device 700 of FIG. 7A that use at least two arms for generating the decompressing force on the patient. Turning to FIG. 7B, a top view of an upward force actuator 720 is shown. The upward force actuator 720 is combined with a chest compression actuator such as a chest compression actuator 104 described above. The force distributing portion 112 is affixed to the belt 106. The upward force actuator 720 includes four collapsible arms 722a, 722b, 722c, and 722d. The arms 722a-d are coupled to the force distributing portion 112 of the chest compression actuator 104 by a central portion 724. In some implementations, the belt 106, force distributing portion 112, central portion 724, and arms 722a-d are modular from the rest of the ACD device 100 and can be removed and added as needed from the platform 102 for ACD treatment. The belt 106, force distributing portion 112, central portion 724, and arms 722a-d may form a removable assembly that is disposable. In some implementations, the arms 722a-d and central potion 724 can be modular with respect to the chest compression actuator 104. The central portion 724 can include a coupling mechanism (e.g., Velcro, adhesive, etc.) so that the arms 722a-d and central portion can be added/removed from the belt 106 and force distributing portion 112 of the chest compression actuator 104.

The arms 722a-d can be inserted into slots in the platform 702, such as near positions 714a-d, respectively, of FIG. 7A. When the central portion 724 is pulled downward during the compression phase by the belt 106 of the chest compression actuator 104, the arms 722a-d bow inward toward each other and are tensioned, as the ends of the arms 722a-d are fixed in the slots of the platform. Thus, the arms 722a-d are configured to bend and be in tension during the compression phase when the belt 106 is tightened to compress the patient. The arms 722a-d are configured to spring back (e.g., re-straighten) at least partially to their original forms to provide a lifting force on the sternum of the patient and decompress the chest of the patient.

In some implementations, the arms 722a-d are coupled to the platform 702 (e.g., by rotating joints, ball and socket joints, etc.). To couple the arms 722a-d with the central portion 724 or chest compression actuator 104, the arms can each be inserted into a sleeve or slot in the central portion (similar to a tent). In some implementations, two longer arms extend entirely across the platform 702, as shown in FIG. 7D. The two arms cross one another but and are coupled by the central portion 724 or some other coupling mechanism. In this example, arms 722a and 722d would be replaced by first arm 740, and arms 722b and 722c would be replaced by second arm 742.

The arms 722a-d each include materials or configurations configured to bend and provide a lifting force to the central portion 724 and/or the chest compression actuator 104. In some implementations, the arms 722a-d each include a pliable or flexible piece of material such as metal or plastic. In some implementations, the arms include telescoping rods that can be shortened or lengthened to tune the magnitude of the decompressing force that is to be exerted on the patient by the upward force actuator 720. In some implementations, the arms 722a-d each include fiberglass rods with an elastic cord as a shock core. The rods can be broken down into segments to lengthen or shorten the rods. In some implementations, the arms 722a-d can be stored in the platform 702 but be removable from the platform. In some implementations, the arms 722a-d are configured to fold in one direction but engage in another direction (e.g., a hinge that opens to 180 degrees).

Turning to FIG. 7C, a side-view of the upward force actuator 720 of FIG. 7B is shown over the patient 708. The arms 722a and 722b are shown to be in tension as the belt 106 has tightened over the chest of the patient 708. Ends 730a, 730b of arms 722a, 722b, respectively, are exerting an upward force on the center of the patient's chest (e.g., through the force distributing mechanism 112 affixed to the patient's chest). The arms 722a, 722b are anchored in the platform 702 in slots 732a, 732b, respectively. When the belt 106 loosens around the patient, the arms 722a, 722b are enabled to re-straighten at least partially back into their original forms and provide a decompressing force near ends 730a, 730b to decompress the patient's thorax. Lengths of the arms and the types of materials used in the arms can be changed to adjust the magnitude of the decompressing force on the patient. In some implementations, the arms 722a-d can be of various lengths to accommodate a variety of chest sizes of respective patients. In some implementations, the magnitude of the decompressing force provided by the arms 722a-d together is between 1-25 lbs. The arms 722a-d can include plastic, metal, fiberglass, aluminum, carbon fiber, and/or glass-filled polycarbonate. For semi-rigid arms, the arms 1102, 1104 may include plastic, metal, carbon fiber, polyurethane overmolded beryllium-copper leaf springs.

Turning to FIG. 7E, a perspective view is shown of the upward force actuator 720. Arms 722a-d are bowed and in tension, similar to the arms shown in FIG. 7C. The arms 722a-d are coupled to the central portion 724. The platform 702 includes slots 750, 752 for receiving the arms 722a, 722d, respectively. Additional slots (not shown) are provided for arms 722b-c.

One or more of the arms 722a-d can be tuned to provide a specific force or force curve for a desired amount of decompression of the patient. For example, one or more of the arms 722a-d can be configured to provide between 1-25 lbs. of predetermined decompression force. In some embodiments, the one or more of the arms 722a-d are configured to provide maximum upward force (e.g. 3, 5, 10, 15, 20 lbs.) at the point of deepest compression, and that decreases as the depth approaches either the zero or neutral point during the decompression phase. In other words, at the start of the decompression phase, the force is greater than at the end of the decompression phase, e.g. the force at end of the decompression phase is, for example, 80%, 50%, 20%, 10%, 5%, or 1% of the force at the start of the decompression phase.

In some embodiments, the upward force actuator 720 can be configured to deliver a sufficient amount of force to achieve a specific depth at the point of maximum decompression upstroke that is either below or above either the zero point or neutral point. In some embodiments, the achieved upward displacement of the chest may be the zero or neutral position of the chest. In another example, the one or more of the arms 722a-d of the upward force actuator 720 can be configured to provide decompression force sufficient to achieve an upward displacement of the chest relative to the neutral or zero position of the chest of about 0.25 to 4 inches. On a typical patient, approximately 5-20 lbs. of upward force would be needed to achieve an upward displacement of 2 inches relative to the neutral or zero position.

In some implementations, the ACD device 700 described herein as utilizing a belt as the chest compression actuator for compressing a patient's thorax may not include the belt but instead may include another device for the chest compression actuator 104. For example, the ACD device 700 may include a piston or other rigid device to compress the chest of the patient. The arms 722a-d can couple to the piston device and exert the upward decompressing force on the piston, which is affixed to and pulls up upon the chest of the patient. Alternatively, the arms can be coupled directly to the patient's thorax and pull up upon the chest of the patient.

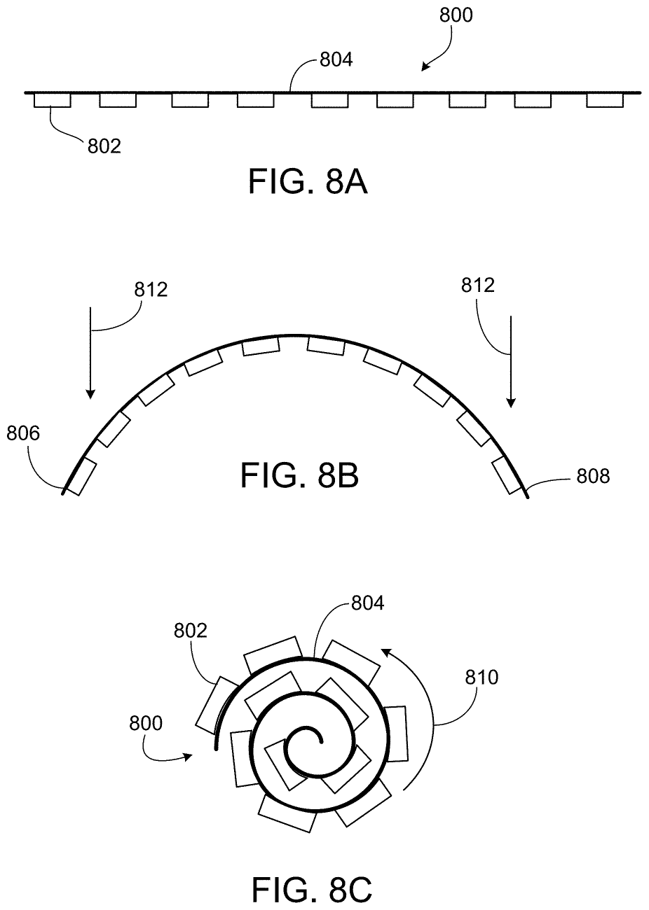

FIGS. 8A-8C show examples of collapsible arms for the upward force actuators for ACD devices described herein, e.g., FIGS. 1-7E. FIG. 8A shows a collapsible arm 800. The arm 800 is configured to act as a rigid arm when force is applied to one or more of the ends 806 and 808, as shown in FIG. 8B. The arm 800 includes segments 802 and a flexible backing 804. When the arm 800 is flexed as shown in FIG. 8B by arrows 812, the arm 800 forms an arch. When the arm 800 is flexed in an opposite direction as show by arrow 810 in FIG. 8C, the arm can roll up or otherwise collapse. In some implementations, the arm 800 can be collapsed for storage purposes. For example, the arm 800 can be stored in the platform (e.g., platform 102 of FIG. 1). When ACD treatment is to commence, the arm 800 can be removed from the platform and the ends 806, 808 can be coupled to the platform such that the arm 800 forms a rigid arch. In other implementations, only a single end 806 or 808 may be coupled to the platform with the non-coupled end positioned over the patient or coupled to a second arm positioned over the patient. In some implementations, the arm 800 is a monolithic material that includes both the segments 802 and the backing 804 in a single piece of material. In some implementations, the arm 800 includes a series of segments each comprising a rigid material affixed to a flexible backing material.

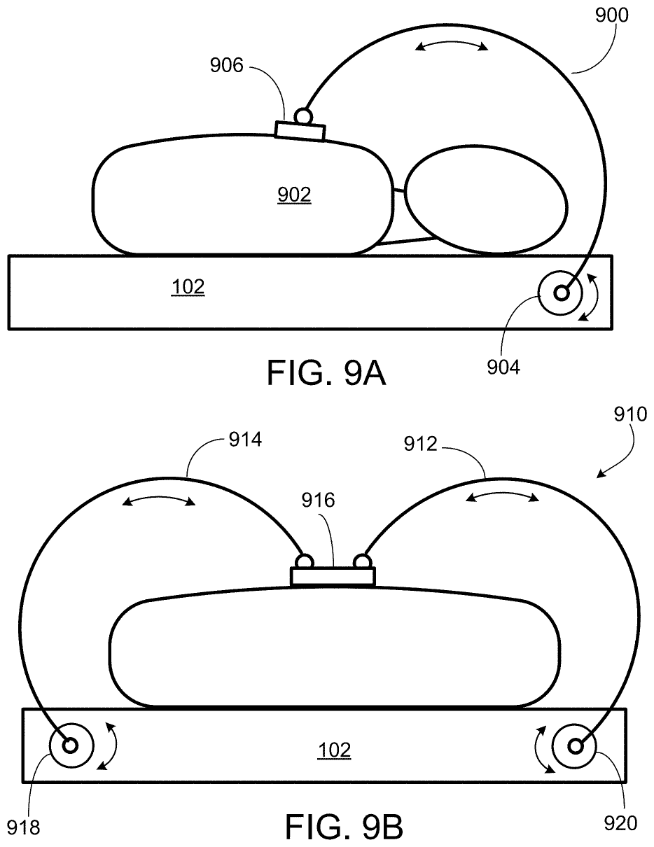

FIGS. 9A-9B show ACD devices including examples of upward force actuators. In both FIGS. 9A-9B, the upward force actuators include a leaf spring mechanism that flexes either actively or passively to exert a decompressing force on the patient 902. Turning to FIG. 9A, a side view is shown of an upward force actuator 900, which includes a leaf spring 908 extension from the platform 102. The leaf spring 908 is coupled to the platform by a coupling mechanism 904. The coupling mechanism 904 includes a joint for rotating the leaf spring 908 relative to the platform 102. In some implementations, the coupling mechanism includes an actuator that can actively rotate the leaf spring 908 as shown by the arrow near the coupling mechanism 904. The actuator can control the leaf spring 908 to exert a decompression force on the patient 902 actively by rotating the leaf spring 908 up and away from the patient. The leaf spring 908 is coupled to the patient by a coupling mechanism 906 (e.g., either directly or through the chest compression actuator 104, e.g., a belt 106 and load distribution portion 112, as described above). When the actuator rotates in a clockwise direction as shown in FIG. 9A, the leaf spring 908 pulls upward on the patient's chest. In some implementations, the leaf spring 908 can passively provide a decompression force to the patient by a tension that occurs in the leaf spring during the compression phase of the ACD compression cycle, e.g., where the leaf spring is coupled to the chest compression actuator or positioned between the patient's chest and the chest compression actuator, such that compression by the chest compression actuator causes the leaf spring to flex or bend in tension. When the belt 106 loosens about the patient, the leaf spring 908 releases the tension and pulls upward on the patient's chest. Here, the leaf spring 908 extends over the head of the patient 902, providing the rescuer access to the sides of the patient if needed. Alternatively, the leaf spring may extend from a side of the platform over the patient or be able to maneuver around or extend from any side or end of the platform to provide maximum flexibility with respect to patient access.

Turning to FIG. 9B, an axial view of an upward force actuator 910 with at least two leaf springs is shown. In FIG. 9B, two leaf springs, 912, 914, are shown and couple to the patient at the coupling device 916 in a similar manner as the leaf spring 908 of FIG. 9A (e.g., either directly or through the chest compression actuator 104, e.g., a belt 106 and load distribution portion 112). Two actuators, 918 and 920, can rotate in a similar manner as actuator 904 to cause the leaf springs 912, 914 to exert the decompressing force on the thorax of the patient 902. Here, the leaf springs 912, 914 extend from the sides of the platform 102 over the patient 902. Alternatively, the leaf springs may extend from the platform, over the head of a patient or be able to maneuver around or extend from any side or end of the platform to provide maximum flexibility with respect to patient access.

The leaf springs 908, 912, 914, and (if applicable) their respective actuators 918, 920, can be tuned to provide a specific force or force curve for a desired amount of decompression of the patient. For example, one or more of the leaf springs 908, 912, 914, and (if applicable) their respective actuators 918, 920 can be configured to provide between 1-25 lbs. of predetermined decompression force. In some embodiments, leaf springs 908, 912, 914, and (if applicable) their respective actuators 918, 920 are configured to provide maximum upward force (e.g. 3, 5, 10, 15, 20 lbs.) at the point of deepest compression, and that decreases as the depth approaches either the zero or neutral point during the decompression phase. In other words, at the start of the decompression phase, the force is greater than at the end of the decompression phase, e.g. the force at end of the decompression phase is, for example, 80%, 50%, 20%, 10%, 5%, or 1% of the force at the start of the decompression phase.

In some embodiments, the upward force actuator 910 can be configured to deliver a sufficient amount of force to achieve a specific depth at the point of maximum decompression upstroke that is either below or above either the zero point or neutral point. In some embodiments, the achieved upward displacement of the chest may be the zero or neutral position of the chest. In another example, the leaf springs 908, 912, 914, and (if applicable) their respective actuators 918, 920 of the upward force actuator 910 can be configured to provide decompression force sufficient to achieve an upward displacement of the chest relative to the neutral or zero position of the chest of about 0.25 to 4 inches. On a typical patient, approximately 5-20 lbs. of upward force would be needed to achieve an upward displacement of 2 inches relative to the neutral or zero position.

In some implementations, the ACD device described herein as utilizing a belt as the chest compression actuator for compressing a patient's thorax may not include the belt but instead may include another device for the chest compression actuator 104. For example, the ACD device 100 may include a piston or other rigid device to compress the chest of the patient. The leaf springs 908, 912, 914 can couple to the piston device and exert the upward decompressing force on the piston, which is affixed to and pulls up upon the chest of the patient. Alternatively, the leaf spring can be coupled directly to the patient's thorax and pull up upon the chest of the patient.

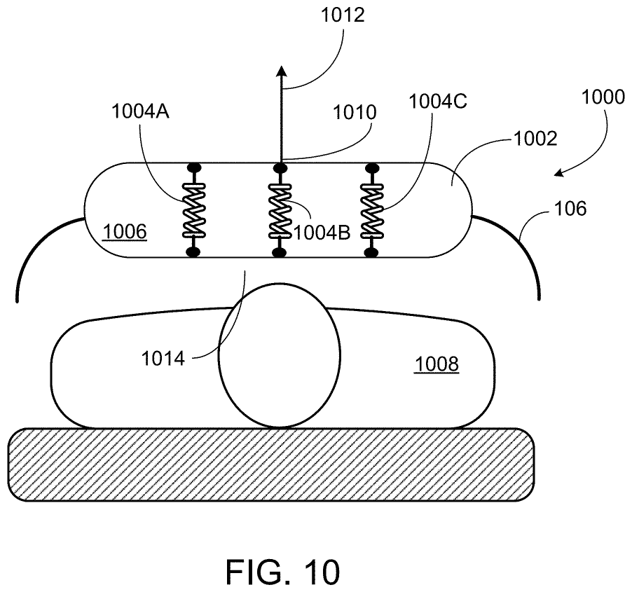

FIG. 10 shows an example of a compression belt, including an example of a force distributing mechanism 1000 affixed to a belt 106 of the chest compression actuator 104 for ACD devices described herein, e.g., FIGS. 1-9B. In any embodiment described herein in which the upward force actuator is coupled to the belt 106 and/or the force distributing mechanism of the chest compression actuator 104, the chest compression actuator is able to transfer the decompressing force of the upward force actuator to the patient. In such implementations, the chest compression actuator 104 includes a high strength material having a high tensile strength (e.g., capable of supporting up to several hundred pounds). The high-tensile strength of the material of the chest compression actuator 104 ensures that the decompressing force that pulls on the chest compression actuator also pulls on the patient to which the chest compression actuator 104 is affixed.

The force distributing mechanism 1000 is configured to spread the compressing force (and in some implementations, the decompressing force) of the chest compression actuator 104 during the compression cycle. The force distributing mechanism 1000 may include a bladder 1002 or other fluid filled container that is affixed to the belt 106. When the belt 106 tightens around the patient 1008, the compressing force is spread over the thorax of the patient by the bladder 1002. For example, the pressure exerted by the bladder on the patient can be less than 5.7 PSI.

The bladder 1002 may include a fluid filled (air or liquid) interior 1006. In some implementations, the interior 1006 can be foam instead of fluid. The interior 1006 may include a plurality of tension cords 1004a-c which transfer the force exerted by the upward force actuator (e.g., shown by arrow 1012) at point 1010 on the top surface of the bladder 1002 to the bottom surface 1014, and to the thorax of the patient 1008, which is affixed to the bottom surface 1014 of the bladder 1002.

The plurality of tension cords 1004a-c can include elastic elements such as springs, bungees, etc. The plurality of tension cords 1004a-c are distributed throughout the bladder 1002 interior 1006 so that the bladder 1002 does not deform substantially when transferring the decompressing force from the upward force actuator to the patient.

In some implementations, the upward force actuator is affixed to the bladder 1002 at a single point 1010 (as shown in FIG. 10). However, the upward force actuator can be affixed or coupled to the bladder at multiple points (e.g., if many leaf springs are used, as described above in reference to FIG. 9B). In some implementations, the upward force actuator can couple to the bladder 1002 using a larger surface (e.g., the central portion 724 of FIGS. 7B-7E). In some implementations, the upward force actuator is coupled to a different portion of the chest compression actuator 104 that is not the force distributing portion 1000 (e.g., the belt 106).

When the upward force actuator is coupled to the chest compression actuator 104, the chest compression actuator 104 is affixed to the patient's thorax by a coupling mechanism. This is because the upward force actuator couples with the patient's chest wall in order to pull up on the chest wall and decompress the patient 1008. The chest compression actuator 104 is affixed to the chest of the patient 1008. In some implementations, the force distributing mechanism 1000 is the portion of the chest compression actuator 104 that is affixed to the patient 1008.

In some implementations, the force distributing mechanism 1000 is affixed to the chest by an adhesive. The adhesive includes a dermal adhesive that affixes the bladder 1002 to the patient 1008. The adhesive can be selected to limit the amount of decompressing force that can be exerted on the patient. For example, an adhesive can be selected which supports up to 1-25 lbs of force before detaching from the patient 1008. Adhesives can include one or more dermal adhesives. Adhesives can include at least the materials shown in Table 1, above.

In some implementations, the adhesive is compliant with the chest surface of the patient, and is hydrophilic and can tolerate contaminants (e.g., hair, sweat, etc.) between the bladder 1002 bottom surface 1014 and the patient 1008. In some implementations, when a compression is performed (e.g., up to 120 lbs. of force), the adhesive is resealed on the patient during each cycle (e.g., if the adhesive starts to peel during the decompression phase).

In some implementations, the force distributing mechanism 1000 is adhered to the patient 1008 by suction cups. Similar to the adhesive, the suction of the suction cups can be reset during the compression phase of the compression/decompression cycle. The suction cups may include a natural leaking system such that the suction cups automatically vent during use. In some implementations, the suction cups can be large scale (e.g., on the order of several centimeters in diameter). In some implementations, the suction cups can be microscale cups (e.g., on the order of several micrometers in diameter). The number of suction cups can range from a single suction cup to several thousand suction cups.

In some implementations, the upward force actuator does not couple to the top of the chest compression actuator 104 (e.g., to the top surface of the force distributing mechanism 1000). Rather, the upward force actuator is configured to couple directly to the patient below the chest compression actuator 104 to eliminate the need for the tension cords

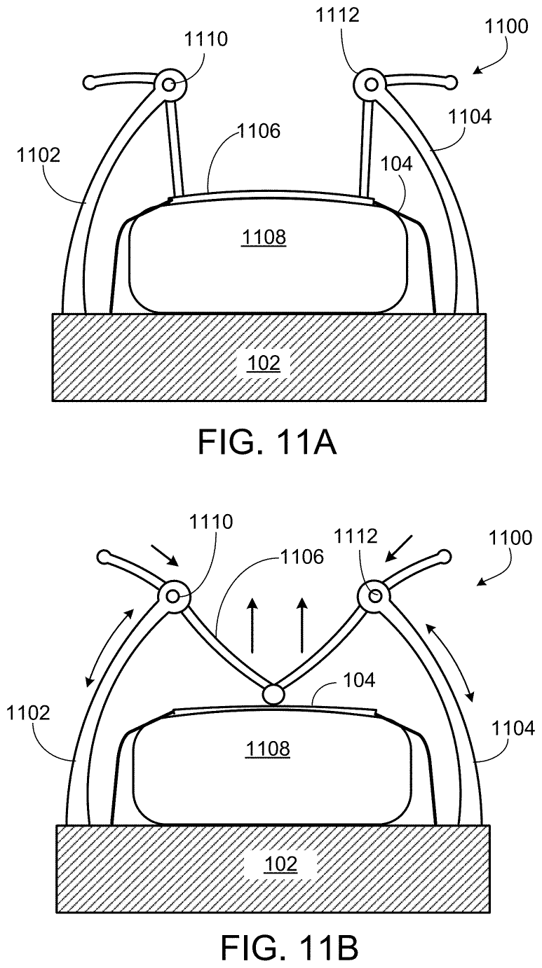

FIGS. 11A-11B show ACD devices including example upward force actuator 1100. Arms 1102, 1104 extend from the platform 102 on either side of the patient 1108. The arms can be rotatably coupled to the platform 102 to rotate from a storage position (e.g., along the length of and approximately parallel to the platform 102) to an upright position (shown in FIGS. 11A-11B) for use in the ACD treatment. The arms 1102, 1104 can be formed from a rigid material, such as fiberglass, plastic, metal, aluminum, carbon fiber, glass-filled polycarbonate. For semi-rigid arms, the arms 1102, 1104 may include carbon fiber, polyurethane overmolded beryllium-copper leaf springs etc. The arms may formed of metals, polymers or natural products, alone or in composite to generate areas of stiffness and flexibility for desired function. The arms may include multiple segments combined with springs at the joints to generate forces. Alternatively, the arms may include rigid members with an elastic strap to act as the force actuator.

In some implementations, the arms can include metal, polymer or natural products, either alone or in composite, to generate areas of stiffness and flexibility for providing an upward force via the strap. In some implementations, the arms 1102, 1104 can include multiple segments combined with springs at the joints to generate forces. In some implementations, the arms 1102, 1104 include rigid members with an elastic strap 1106 to act as the force actuator.

A strap 1106 is affixed to each of arms 1102, 1104 on either side of the patient. The strap 1106 is also affixed to the patient 1108 directly or indirectly by the chest compression actuator 104 (e.g., as described above in relation to FIG. 10) at the ends or center of the sternum or chest compression actuator. In some implementations, the strap 1106 is configured to affix to the patient by a coupling mechanism such as a dermal adhesive, suction cups, etc. In some implementations, the strap 1106 is configured to couple with the chest compression actuator 104 by Velcro®, through loops in the chest compression actuator, etc.

In some implementations, the strap 1106 includes a single member with each end of the member attached to an arm 1102, 1104 and loosely passing through the anchor or rigidly affixed to the patient by the coupling mechanism. In some implementations, the strap 1106 includes discrete attachment point/points to the patient coupling mechanism to aid the coupling mechanism to resist peeling away from the patient. In some implementations, the strap 1106 connects to the arms 1102, 1104 are variable to adjust the force applied to the patient (e.g., based on patient size).

Turning to FIG. 11A, when the patient is in an, uncompressed state, the strap 1106 is clamped to the arms 1102, 1104 and affixed to the patient. The strap 1106 can be clamped to the arm at coupling devices 1110, 1112. Coupling devices 1110, 1112 can include clamps, loops, buckles, etc. The arms 1102, 1104 extend approximately vertically and can bow slightly over the patient. Turning to FIG. 11B, when the chest compression actuator 104 compresses the patient's chest, the strap pulls on each of the arms 1102, 1104, causing a tension in each of the arms. The arms bow over the patient and pull upward on the strap 1106. When the chest compression actuator 104 allows the belt 106 to loosen about the patient, the arms 1102, 1104 each spring back to re-straighten and pull upward on the strap 1106 affixed to the patient's chest, decompressing the patient's chest.

The arms 1102, 1104 can be tuned to provide a specific force or force curve for a desired amount of decompression of the patient. For example, one or more of the arms 1102, 1104 can be configured to provide between 1-25 lbs. of predetermined decompression force. In some embodiments, the arms 1102, 1104 are configured to provide maximum upward force (e.g. 3, 5, 10, 15, 20 lbs.) at the point of deepest compression, and that decreases as the depth approaches either the zero or neutral point during the decompression phase. In other words, at the start of the decompression phase, the force is greater than at the end of the decompression phase, e.g. the force at end of the decompression phase is, for example, 80%, 50%, 20%, 10%, 5%, or 1% of the force at the start of the decompression phase.

In some embodiments, the upward force actuator 1100 can be configured to deliver a sufficient amount of force to achieve a specific depth at the point of maximum decompression upstroke that is either below or above either the zero point or neutral point. In some embodiments, the achieved upward displacement of the chest may be the zero or neutral position of the chest. In another example, the arms 1102, 1104 of the upward force actuator 1100 can be configured to provide decompression force sufficient to achieve an upward displacement of the chest relative to the neutral or zero position of the chest of about 0.25 to 4 inches. On a typical patient, approximately 5-20 lbs. of upward force would be needed to achieve an upward displacement of 2 inches relative to the neutral or zero position.

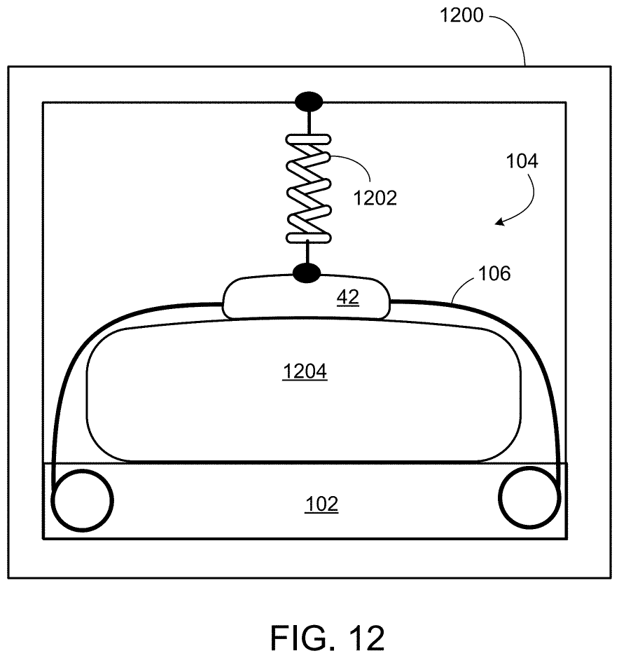

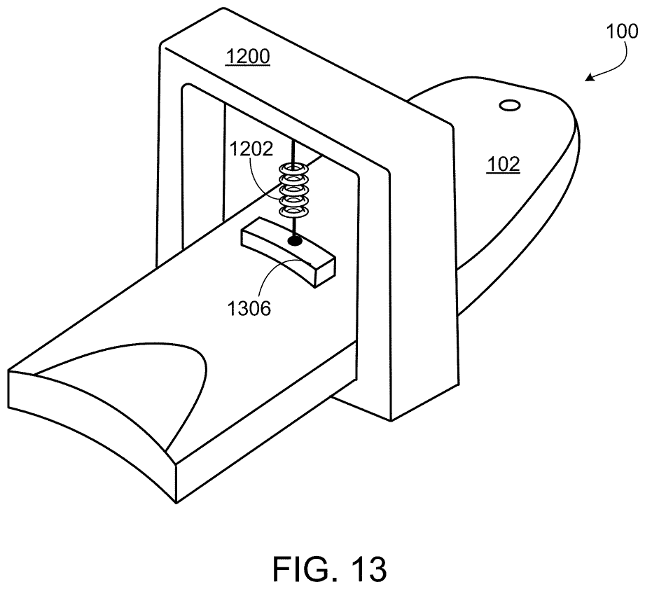

FIGS. 12-13 show example upward force actuators configured to couple to an external structure 1200 for an ACD device. Turning to FIG. 12, an external structure 1200 is positioned near to the ACD device 100 as shown in an axial view. An elastic device 1202 is coupled to the patient 1204, either being directly affixed to the patient or coupled to the patient by the chest compression actuator 104. For example, the elastic device 1202 is coupled to the force distributing mechanism 112 of the chest compression actuator 104. When the chest compression actuator 104 compresses the chest of the patient 1204 by tightening the belt 106, the elastic device 1202 is extended and exerts a lifting force on the force distributing mechanism 112. When the chest compression actuator 104 loosens the belt 106, the elastic device 1202 pulls upward on the force distributing mechanism 112, which is affixed to the patient, and exerts a decompressing force on the patient 1204. The elastic device 1202 is coupled to the force distributing mechanism (or another portion of the chest compression actuator 104) by a hook or latch, or a loop and hook system, Velcro®, etc. In some implementations, the elastic device 1202 is affixed to a coupling surface that is coupled directly to the patient that is not a portion of the chest compression actuator 104. The coupling surface, e.g., a plate can be positioned under the chest compression actuator 104 or on another portion of the patient 1204.

The elastic device 1202 can include one or more of a spring, elastic material, bungee cord, etc. The elastic device 1202 is configured to couple to a portion of the external structure 1200. For example, the external structure 1200 can include a hook, latch or loop, and the elastic device 1202 can include a corresponding hook, latch or loop to couple to the external surface. In some implementations, the elastic device 1202 can include an adhesive, suction cup, etc. so that the elastic device can couple to a variety of external surfaces.

In some implementations, the elastic device 1202 is affixed directly to the patient, and when the belt 106 is loosened by the chest compression actuator 104, the elastic device is allowed to decompress the patient's chest. In this example, the elastic device 1202 can be affixed to the patient by a coupling mechanism such as a dermal adhesive, one or more suction cups, etc.

As described above, the elastic device 1202 includes a first end configured to couple to the external structure and a second end configured to couple to the patient. For one or both ends of the elastic device 1202, the strength of the coupling mechanism can be configured to remain coupled up to a maximum magnitude of force exerted on the patient. For example, the elastic element 1202 can include an adhesive configured to support 1-25 lbs. of force before detaching from the patient (e.g., breaking away from the patient). Adhesives can include one or more dermal adhesives. Adhesives can include at least the materials shown in Table 1 above, suction cups or other. In some implementations, the coupling mechanism can be designed to break away when the force exceeds the maximum decompressing force. For example, a breakaway hinge, hook, loop, etc. can be built into the elastic device 1202 and/or structure 1204 to limit the maximum decompressing force.

The external structure 1204 can be provided with the ACD device 100 or can be a standalone structure. The structure 1204 can be any rigid structure that is supported by a mechanism other than the platform 102. Turning to FIG. 13, a perspective view of the external structure 1200 is shown. The external structure 1200 can be a ceiling of an ambulance, hospital room, etc. The external structure 1200 can be a rigid structure that is mobile, collapsible for transport and/or provided with the ACD device 100. The external structure 1200 can include the elastic device 1202 and coupling mechanism 1306 that is configured to couple with the chest compression actuator 104 and/or directly to the patient.

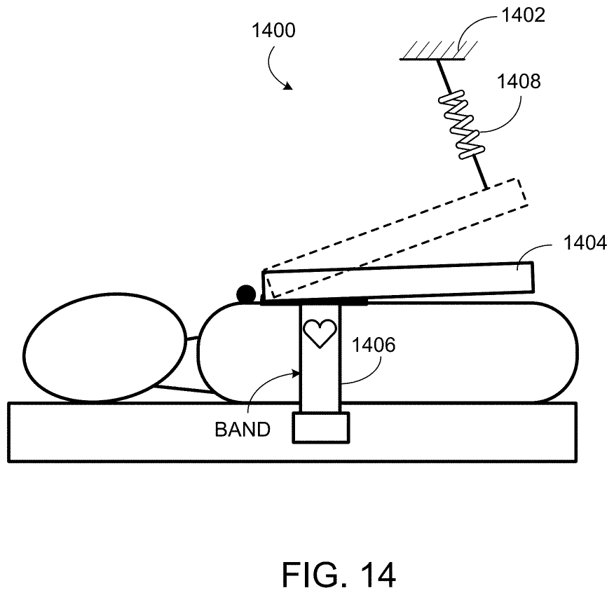

FIG. 14 shows a side view of an ACD device 1400 that is configured to couple to an external structure 1402 (or optionally to an arm, rod or structure coupled to the platform as described in the above embodiments). The ACD device 1400 includes a lever arm 1404 that is affixed to the chest compression actuator 1406 of the ACD device 1400. In some implementations, the lever arm 1404 and chest compression actuator 1406 are a single device. In some implementations, the lever arm 1404 and the chest compression actuator 1406 are separate, modular devices. Similar to the ACD device of FIGS. 12-13, the ACD device 1400 may include an elastic device 1408 that couples the lever arm 1404 to an external structure 1410.

The lever arm 1404 includes a rigid material that transfers a force from the elastic device 1408 to the patient (e.g., by the chest compression actuator 1406 and/or directly to the patient 1412). The length of the lever arm 1404 is sized to tune the magnitude of the decompression force on the patient 1412. Adjusting the length of the lever arm 1404 can allow more tolerance in the characteristics of the elastic device 1408 so that the magnitude of the decompressing force can be finely tuned without requiring a particular elastic device. For example, the lever arm 1404 can be a telescoping structure that can extend and contract. The length of the lever arm 1404 can be adjusted based on the size of the patient and/or the magnitude of decompressing force desired. The length of the lever arm 1404 can also be adjusted based on the relative position of the external structure 1410 or other rod or arm (e.g., based on a distance of the external structure from the patient's chest).

The lever arm 1404 forms an anatomical hinge with the center of the patient's rib cage and thus can provide a greater decompressing force on the chest wall of the patient. The lever arm 1404 acts as a class I lever, pulling upward on the patient's chest with relatively large force while requiring a relatively small force from the elastic device 1408. For example, a tension force of the elastic device 1408 can be applied to obtain a decompression force in the range of 1-25 lbs on the thorax of the patient.

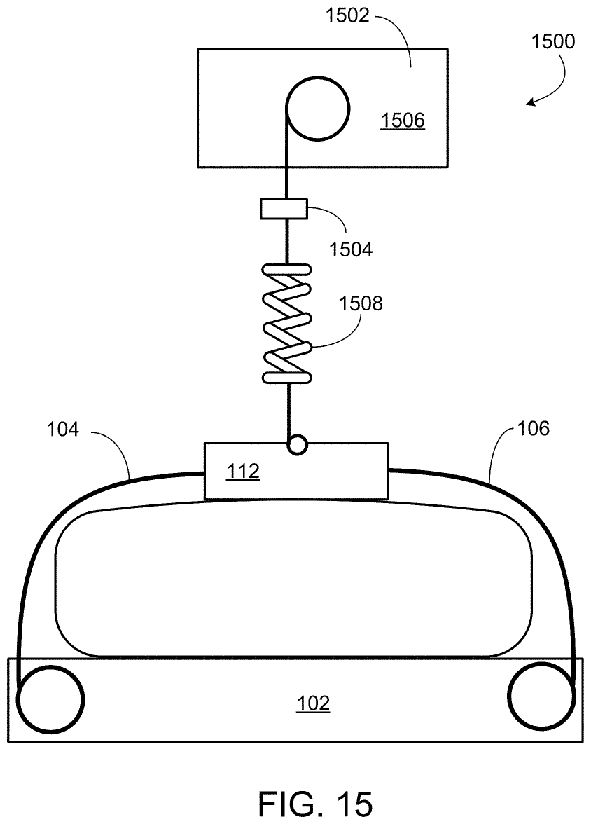

Turning to FIG. 15, FIG. 15 shows an ACD device including an example upward force actuator 1500 including an independent decompression device 1502, which may be used in other ACD devices, e.g., FIGS. 12-14. The independent decompression device 1502 includes a feedback sensor 1504 that measures the magnitude of the force being exerted on the patient for decompression and/or compression of the patient. In some implementations, the feedback sensor 1504 includes a force sensor, such as a strain sensor, load cell, etc., to directly measure the force being exerted on the patient. In some implementations, the feedback sensor includes a shaft encoder to measure how much a cord or other mechanism has extended in order to indirectly measure the force being exerted on the patient. Similar to the ACD devices of FIG. 12-14, an external structure 1506 (or other structure extending from the platform) may be coupled to the ACD device by a coupling mechanism 1508. In some implementations, the coupling mechanism need not be elastic. Rather, the coupling mechanism can include a rigid material that is driven up and down to exert compression and decompression forces on the patient (e.g., similar to or including a piston). A motor 1510 can drive the coupling mechanism to provide compression and decompression forces on the patient. In some implementations, the coupling mechanism is an elastic element coupled to the chest compression actuator 104, such as to the force distributing mechanism and/or the belt 106.

The independent decompression device 1500 can be tuned to provide a specific force or force curve for a desired amount of decompression of the patient. For example, the independent decompression device 1500 can be configured to provide between 1-25 lbs. of predetermined decompression force. In some embodiments, the decompression device 1502 is configured to provide maximum upward force (e.g. 3, 5, 10, 15, 20 lbs.) at the point of deepest compression, and that decreases as the depth approaches either the zero or neutral point during the decompression phase. In other words, at the start of the decompression phase, the force is greater than at the end of the decompression phase, e.g. the force at end of the decompression phase is, for example, 80%, 50%, 20%, 10%, 5%, or 1% of the force at the start of the decompression phase.

In some embodiments, decompression device 1502 can be configured to deliver a sufficient amount of force to achieve a specific depth at the point of maximum decompression upstroke that is either below or above either the zero point or neutral point. In some embodiments, the achieved upward displacement of the chest may be the zero or neutral position of the chest. In another example, the decompression device 1502 can be configured to provide decompression force sufficient to achieve an upward displacement of the chest relative to the neutral or zero position of the chest of about 0.25 to 4 inches. On a typical patient, approximately 5-20 lbs. of upward force would be needed to achieve an upward displacement of 2 inches relative to the neutral or zero position.

In some implementations, the independent decompression device 1500 can affix to the patient under the compression belt 106. The belt 106 tightens to pull the upward force actuator down. When the chest compression actuator causes the belt to loosen, the upward force actuator pulls the patient's chest upward and decompresses the chest of the patient.

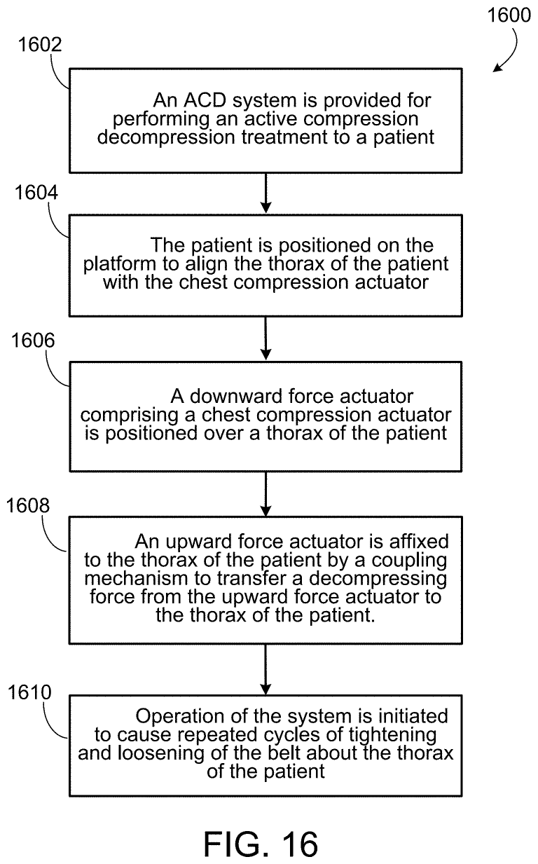

FIG. 16 shows an example process 1600 for performing ACD treatment using the ACD devices of FIGS. 1-15. An ACD system is provided (1602) for performing an active compression decompression treatment to a patient. The patient is positioned on a platform so that the platform is under the patient. The patient is positioned (1604) on the platform to align the thorax of the patient with the belt. A chest compression actuator (e.g., comprising a belt) is extended (1606) over a thorax of the patient. The belt extends from the platform on a first side of the patient to a second side of the patient opposite the first side. An upward force actuator is affixed (1608) to the thorax of the patient by a coupling mechanism to transfer a decompressing force from the upward force actuator to the thorax of the patient. The upward force actuator is coupled to the thorax of the patient either directly by a dermal adhesive or indirectly by being coupled to the belt. A motor that is coupled to the belt is configured to cause the belt to tighten about the thorax of the patient and exert a compressing force on the thorax of the patient and cause the belt to loosen about the thorax of the patient and allow the upward force actuator to exert a decompressing force on the thorax of the patient. Operation of the system is initiated (1610) to cause repeated cycles of tightening and loosening of the belt about the thorax of the patient.

In some implementations, the chest compression actuator includes a piston. The piston mechanism is positioned over the patient's chest and is configured to apply a compressing force to the patient's chest. A motor coupled to the piston mechanism is configured to cause a piston to compress the patient's chest by moving downward against the patient's chest. The motor is configured to move the piston upward away from the patient's chest and allow the upward force actuator to exert a decompressing force on the thorax of the patient.

FIG. 17 shows an example computing device 1700 for controlling one or more operations of the ACD devices of FIGS. 1-16 and 18A-18C and performing the process of FIG. 16. Embodiments can be implemented in digital electronic circuitry, in computer hardware, firmware, software, or in combinations thereof. Apparatus of the invention can be implemented in a computer program product tangibly embodied or stored in a machine-readable storage device for execution by a programmable processor 1710; and method actions can be performed by a programmable processor 1710 executing a program of instructions to perform functions of the invention by operating on input data and generating output. The embodiments can be implemented advantageously in one or more computer programs that are executable on a programmable system including at least one programmable processor 1710 coupled to receive data and instructions from, and to transmit data and instructions to, a data storage system 1730, at least one input device 1740, and at least one output device. Each computer program can be implemented in a high-level procedural or object oriented programming language, or in assembly or machine language if desired; and in any case, the language can be a compiled or interpreted language.

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices 1720 for storing instructions and data. Generally, a computer will also include, or be operatively coupled to receive data from or transfer data to, or both, one or more mass storage devices 1730 for storing data, e.g., magnetic, magneto optical disks, or optical disks. Data can be transferred via one or more communication protocols including Bluetooth, TCP/IP, RFID (or other near field communications), WIFI, etc. Computer readable media for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry. Any of the foregoing can be supplemented by, or incorporated in, ASICs (application-specific integrated circuits).

To provide for interaction with a user, embodiments can be implemented on a computer having a display device, e.g., a LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. The display device can be used for inputting instructions (e.g., decompression and/or compression magnitude settings) for the devices of FIGS. 1-15.

The computing device 1700 can form the controller for controlling the ACD treatment of the ACD device. The computing device 1700 can control the frequency of the compression cycles of the ACD treatment as well as the depth, force magnitude, period, and number of cycles of the ACD treatment.

FIGS. 18A-18C show examples of an ACD device 1800. ACD device 1800 includes a chest compression actuator 1802 that provides the compressing force on the patient 128 by a piston mechanism 1804. The piston mechanism 1804 includes a suction cup 1806 (or other such coupling mechanism, such as those described above) and a piston element 1842 that is coupled to the suction cup and an actuator (e.g., a motor) that drives the piston into the patient's chest. The suction cup 1806 is configured to affix to the patient 128. The piston mechanism 1804 is interfaced with one of the upward force actuators described above.

For example, FIG. 18A shows the piston mechanism 1804 interfaced with the arm 122 that forms a portion of the upward force actuator 1820. The upward force actuator 1820 includes the arm 122 extending over the patient 128 and the elastic element 124 (e.g., similar to upward force actuator 120). The elastic element 124 couples to the suction cup 1806 with the coupling device 126. The elastic element 124 is configured to pull up on the suction cup of the piston mechanism 1804 to provide the decompressing force on the patient. The upward force actuator 1820 and chest compression actuator 1802 work together to apply both compressions and decompressions to the patient 128 for ACD treatment. The configuration shown in FIG. 18A includes an upward force actuator 1820 and the chest compression actuator 1802 that are approximately parallel to each other. However, other configurations of the upward force actuator 1820 and the chest compression actuator 1802 are possible, as long as each are capable of providing decompressing and compressing forces, respectively, to the patient 128. In this way, an ACD device that has no compression belt provides ACD treatment.

The upward force actuator 1820 is shown as being similar to upward force actuator 120 of FIG. 1, but any of the upward force actuators described above can be combined with the piston mechanism 1804 for providing ACD treatment. In some implementations, the upward force actuator 1820 is configured to couple directly to the patient's chest for providing decompressing forces. In some implementations, the upward force actuator 1820 couples to the piston mechanism 1804 or to the suction cup 1806 to provide the decompressing force by means of the chest compression actuator 1802.

The piston mechanism 1804 can include one or more sensors for measuring a position of the piston and a force being exerted by the piston. For example, the piston can include an encoder that is coupled to the actuating device (e.g., a motor) that drives the piston into the patient's chest. A force sensor can be positioned on the end of the piston element 1842 to measure the compressive force being exerted by the piston on the patient 128. When the piston is driven downward, the upward force actuator 1820 is configured to exert a decompressing force on the patient 128. When the piston mechanism 1804 is released by the downward force actuator 1802, the upward force actuator 1820 pulls the piston back up and decompresses the patient's chest. The sensor may communicate the position of the piston to a controller of the ACD device to control the upward force actuator such that the upward force actuator exerts enough force to effect sufficient decompression.

The chest compression actuator 1802 and upward force actuator 1820 can be tuned to provide specific forces or force curves for a desired amount of compression and/or decompression of the patient. For example, the upward force actuator 1820 can be configured to provide between 1-25 lbs. of predetermined decompression force. In some embodiments, the upward force actuator 1820 is configured to provide maximum upward force (e.g. 3, 5, 10, 15, 20 lbs.) at the point of deepest compression, a force that decreases as the depth approaches either the zero or neutral point during the decompression phase. In other words, at the start of the decompression phase, the force is greater than at the end of the decompression phase, e.g. the force at end of the decompression phase is, for example, 80%, 50%, 20%, 10%, 5%, or 1% of the force at the start of the decompression phase.

In some embodiments, the upward force actuator 1820 can be configured to deliver a sufficient amount of force to achieve a specific depth at the point of maximum decompression upstroke that is either below or above either the zero point or neutral point. In some embodiments, the achieved upward displacement of the chest may be the zero or neutral position of the chest. In another example, the upward force actuator 1820 is configured to provide decompression force sufficient to achieve an upward displacement of the chest relative to the neutral or zero position of the chest of about 0.25 to 4 inches. On a typical patient, approximately 5-20 lbs. of upward force would be needed to achieve an upward displacement of 2 inches relative to the neutral or zero position.

FIG. 18B shows an axial view of a piston-based ACD device 1830 including an alternative upward force actuator to the upward force actuator 1820 shown in FIG. 18A.

An arm 1832 extends over a piston mechanism 1804. The arm can be similar to the arm 318 of FIG. 3E. An elastic element 124 is coupled to the suction cup 1806 and/or the arm 1832 to pull the suction cup, and thus the chest of the patient, upward in response to the piston being driven downward into the chest of the patient to compress the patient's chest. A motor (not shown) or other actuator can be used to provide the downward force on the patient in the piston mechanism 1804. For ACD treatment, the piston mechanism 1804 compresses the patient's chest by driving the suction cup into the patient's chest. The elastic element 124, supported by the arm 1832, pulls up on the suction cup and provides about 1-25 lbs. of decompressing force on the patient's chest. The arm 1832 is adjustable so that the amount of compressing and decompression force can be adjusted.

Turning to FIG. 18C, an alternative upward force actuator 1840 is shown in combination with the piston-based ACD device 1800 of FIG. 18A. The elastic element 124 in FIG. 18C is configured to be included inside of the piston mechanism 1804 and is coupled to the arm 122 and/or the suction cup 1806. For example, the elastic element 124 can include a spring that wraps around the piston element 1842 inside the piston mechanism 1804.

In various embodiments described herein, the upward force actuator may be configured to provide 1-35 lbs. of decompression force.

A number of embodiments of the ACD device have been described. Nevertheless, it will be understood that various modifications may be made without departing from the spirit and scope of the ACD devices. Accordingly, other embodiments are within the scope of the following claims.

1. A system for performing an active compression decompression (ACD) treatment on a patient, the system comprising:
a platform for placement under a patient;
a chest compression actuator comprising a belt configured to extend over a thorax of the patient, the belt configured to extend from the platform on a first side of the patient to a second side of the patient opposite the first side;
an upward force actuator;
a coupling mechanism for coupling the upward force actuator to the thorax of the patient to transfer a decompressing force from the upward force actuator to the thorax of the patient;
a controller; and
a motor that is coupled to the belt and configured to receive one or more signals from the controller, the motor configured to respond to the one or more signals from the controller to:
cause the belt to tighten about the thorax of the patient and exert a compressing force on the thorax of the patient; and
cause the belt to loosen about the thorax of the patient and allow the upward force actuator to cause decompression of the patient.

2. The system of claim 1, wherein the upward force actuator is configured to affix to the thorax of the patient by the coupling mechanism.

3. The system of claim 1, wherein the upward force actuator is configured to couple to the belt, and wherein the belt is configured to affix to the patient by the coupling mechanism.

4. The system of claim 1, wherein the coupling mechanism comprises one or more of suction cups, gel, and adhesive.

5. The system of claim 1, wherein the upward force actuator comprises one or more of a rigid arm, a leaf spring, and an elastic material.

6. The system of claim 1, wherein an amount of the decompression of the thorax of the patient is adjustable based on adjusting a magnitude of the decompressing force on the thorax of the patient by the upward force actuator.

7. The system of claim 6, wherein the magnitude of the decompressing force on the thorax of the patient by the upward force actuator is adjustable by adjusting a tension in the upward force actuator.

8. The system of claim 6, wherein the magnitude of the decompression of the thorax of the patient is adjustable based on adjusting a range of motion of the upward force actuator relative to the platform.

9. The system of claim 1, wherein the upward force actuator is formed by the motor and the belt, wherein the coupling mechanism comprises an adhesive configured to affix the belt to the thorax of the patient, wherein the motor is configured to respond to the one or more signals from the controller to cause the belt to loosen about the thorax of the patient and enable the belt to exert the decompressing force on the thorax of the patient.

10. The system of claim 9, wherein the belt comprises a rigid material, and wherein the belt extends from a first actuator on the first side of the patient to a second actuator on the second side of the patient; and
wherein one of the first actuator or the second actuator comprises the motor.

11. The system of claim 10, wherein at least one of the first and second actuators comprises a rack and pinion configuration to couple the belt to the motor.

12. The system of claim 10, wherein at least one of the first and second actuators is configured to affix to an end of the belt and retract into the platform.

13. (canceled)

14. The system of claim 1, wherein causing the belt to tighten about the thorax of the patient and exert a compressing force on the thorax of the patient comprises
compressing the thorax from an initial state of zero compression past a state of neutral compression to a state of full compression; and
wherein the upward force actuator decompresses the thorax from the state of full compression past the state of neutral compression to the initial state of zero compression.

15. The system of claim 1, the upward force actuator decompresses the thorax from a state of full compression past a state of neutral compression and past an initial state of zero compression to a state of positive decompression.

16. The system of claim 1, wherein the upward force actuator comprises a collapsible arm that is coupled to the platform on the first side of the patient, the second side of the patient, or both the first and second sides of the patient;
wherein the collapsible arm is coupled to the belt or to the thorax of the patient;
wherein the collapsible arm is configured to deform when the motor causes the belt to tighten about the thorax of the patient; and
wherein the collapsible arm is configured to:
re-straighten when the motor causes the belt to loosen about the thorax of the patient thereby exerting the decompressing force on the thorax of the patient.

17. The system of claim 1, wherein the upward force actuator comprises at least one rigid arm configured to couple to the belt or couple to the thorax of the patient, the rigid arm coupled to the platform by a hinge, wherein the rigid arm is configured to rotate about the hinge from a position under the platform to a position over the platform.

18. The system of claim 17, wherein the rigid arm comprises an adjustable pivot point for the hinge.

19. The system of claim 1, wherein the upward force actuator comprises a leaf spring, a rigid arm, or a collapsible arm configured to couple to the belt, wherein the leaf spring, the rigid arm, or the collapsible arm are in tension when the motor causes the belt to tighten about the thorax of the patient, and wherein the leaf spring, the rigid arm, or the collapsible arm is configured to cause the belt to exert the decompressing force on the thorax of the patient when the motor causes the belt to loosen about the thorax of the patient.

20. The system of claim 19, wherein the leaf spring is a first leaf spring, the system comprising a second leaf spring that is coupled to the belt, the first leaf spring being affixed to the platform on the first side of the patient and the second leaf spring being affixed to the platform on the second side of the patient.

21. (canceled)

22. (canceled)

23. The system of claim 1, comprising an arm extending from the platform over the patient, the arm being coupled to the belt or to the thorax of the patient by the upward force actuator.

24. The system of claim 23, wherein a height or a position of the arm is adjustable to adjust a magnitude of the decompressing force of the upward force actuator on the patient.

25. The system of claim 23, wherein the arm comprises a first arm and a second arm, wherein the first arm extends from the platform substantially perpendicular to the platform and the second arm extends from the first arm substantially parallel to the platform, and partially over the patient.

26. The system of claim 25, wherein the second arm is adjustable relative to the first arm.

27. The system of claim 1, wherein the upward force actuator comprises an elastic material configured to be in tension when the motor causes the belt to tighten about the thorax of the patient and configured to exert the decompressing force on the thorax of the patient when the motor causes the belt to loosen about the thorax of the patient.

28.-37. (canceled)

38. The system of claim 23, wherein the arm is a first arm, the system comprising a second arm coupled to the belt and configured to intersect the first arm over the thorax of the patient.

39. The system of claim 38, wherein the first arm or the second arm is adjustable relative to the other of the first and second arms.

40. The system of claim 38, wherein the first arm or second arm comprises a telescoping rod to allow for adjustment of position or height of the first or second arm relative to the platform or thorax of the patient.

41. (canceled)

42. The system of claim 23, wherein the arm comprises a series of segmented sections to permit the arm to be collapsed into a roll and to enable the arm to form a rigid arch.

43.-55. (canceled)

56. The system of claim 1, further comprising a force sensor configured to measure the decompressing force of the upward force actuator.

57.-137. (canceled)

138. The system of claim 56, wherein the controller is configured to control the motor in response to a signal from the force sensor.
